(19) United States
(12) Patent Application Publication
(10) Pub. No.: US 2026/0138621 A1
(43) Pub. Date: May 21, 2026

(54) ON-BOARD VISION LANGUAGE MODELS FOR VEHICLES

(71) Applicant: Waymo LLC, Mountain View, CA (US)

(72) Inventors: Tian Lan, Sunnyvale, CA (US); Shangxuan Wu, Sunnyvale, CA (US); Han Deng, Irvine, CA (US); Xinwei Shi, Cupertino, CA (US); Junhua Mao, Santa Clara, CA (US); Abhishek Sinha, Mountain View, CA (US); Nishant Rai, San Francisco, CA (US); Yukai Liu, Sunnyvale, CA (US); Akshay Smit, San Jose, CA (US); Colin Andrew Braley, Mountain View, CA (US); Kevin Chihpei Sheu, San Jose, CA (US)

(21) Appl. No.: 18/954,373

(22) Filed: Nov. 20, 2024

(51) Int. Cl. B60W 50/00; G05B 13/02

(52) U.S. Cl. CPC B60W 50/0097; G05B 13/027

(57) ABSTRACT

Methods, systems, and apparatus, including computer programs encoded on a computer storage medium, for processing sensor data for a vehicle to perform prediction tasks regarding a driving environment of the vehicle. In one aspect, a method comprises: receiving sensor data comprising an observation of a driving environment, processing the observation using an observation embedding neural network to generate an observation embedding comprising respective observation features associated with each of a plurality of spatial locations within the observation, receiving data characterizing a prediction task, receiving a region proposal specifying a spatial region of the observation, and generating output prediction data characterizing an output prediction for the prediction task and for the region proposal by (i) processing the observation and the region proposal to generate region features characterizing the spatial region and (ii) processing the region features and the data characterizing the prediction task to generate the output prediction data.

### BACKGROUND

This specification relates to processing sensor data characterizing an environment (e.g., a driving environment) for an agent in the environment.

The environment may be a real-world environment, and the agent may be, e.g., a vehicle in the environment.

Processing vehicle sensor data is a task required for motion planning and navigation, e.g., by an autonomous vehicle.

Autonomous vehicles include self-driving cars, boats, and aircraft.

Autonomous vehicles use a variety of on-board sensors and computer systems to detect nearby objects and use such detections to make control and navigation decisions, e.g., by predicting the future trajectories of agents in the vicinity of the autonomous vehicles using the detections.

### BRIEF DESCRIPTION OF THE DRAWINGS

FIG. 1A illustrates an example vehicle sensor data processing task using an on-board observation processing system.

FIG. 1B illustrates an example vehicle sensor data processing task using an off-board observation processing system.

FIG. 2 is a block diagram for an example observation processing system.

FIG. 3 is a flow diagram of an example process for generating a prediction for a particular prediction task by processing sensor data for a vehicle in a driving environment.

FIG. 4 is a flow diagram of an example process for training an observation processing system.

FIG. 5A is a block diagram for an example observation processing system configured to generate output predictions regarding specific spatial regions of a driving environment of a vehicle.

FIG. 5B illustrates generating region features characterizing a specific spatial region of an observation of a driving environment.

FIG. 5C is a flow diagram of an example process for generating a prediction for specific spatial regions of a driving environment of a vehicle by processing sensor data characterizing the driving environment.

FIG. 6A is a block diagram for an example observation processing system configured to generate output predictions for sequences of observations of a driving environment using multiple specialized processing networks.

FIG. 6B is a flow diagram of an example process for generating predictions for sequences of observations of a driving environment using multiple specialized processing networks.

### DETAILED DESCRIPTION

This specification generally describes a system implemented as computer programs on one or more computers in one or more locations that can process sensor data characterizing an environment of a vehicle to generate predictions regarding the environment of the vehicle. In particular, the described systems can receive a query regarding the environment of the vehicle and can process the query alongside the sensor data to generate predictions in response to the query. The described systems can be deployed on-board the vehicle and can process queries from other sub-systems of the vehicle as part of performing a variety of prediction tasks for the vehicle.

Vehicles often include multiple sub-systems configured to perform various data processing and prediction tasks, such as perception systems for processing sensor data collected by vehicle sensors, navigation systems for determining planned vehicle trajectories and control inputs, user interface systems for receiving inputs from and providing information to vehicle users, and so on. The multiple sub-systems of a vehicle typically perform interrelated processing tasks for the vehicle that depend on input data shared among the multiple sub-systems. In particular, many processing tasks for the vehicle depend on processing observations of sensor data obtained by sensors of the vehicle. For example, a perception system of the vehicle can process observations of sensor data to perform, e.g., object detection tasks, segmentation tasks, and so on for the vehicle. As another example, a navigation system of the vehicle can process observations of sensor data to generate planned vehicle trajectories and control inputs for the vehicle. As another example, a user interface system of the vehicle can process the observations of sensor data to generate descriptions of the sensor data for informing a vehicle user.

Conventional data processing systems for vehicles often include a separate, dedicated observation processing neural network for each sub-system that processes observations of sensor data to perform prediction tasks for the vehicle. In conventional data processing systems, each dedicated observation processing neural network for a vehicle sub-system can process network inputs characterizing observations of sensor data to generate predictions regarding the observations of sensor data for the vehicle sub-system. However, including separate observation processing neural networks for multiple vehicle sub-systems can increase system complexity and computational costs for on-board vehicle systems. Complex and computationally costly neural networks can be impractical for use in on-board data processing systems, which can have significant hardware constraints (e.g., memory limitations) resulting from being carried by the vehicle. Reducing the complexity and hardware requirements of observation processing systems is therefore a key challenge for deployment onboard autonomous vehicle systems.

The systems described in this specification address these challenges to practical on-board data processing for vehicles by using a shared observation processing system to process queries from other vehicle sub-systems and the observations of sensor data to generate predictions for the other vehicle sub-systems. For example, by receiving appropriate queries from a navigation system and a user interface of the vehicle, the shared observation processing system can generate predictions relating to the immediate safety of the vehicle (e.g., classifications of hazards to the vehicle within the driving environment, classifications of an operational safety of the vehicle, etc.) to the navigation system, predictions relating to long-term navigational planning (e.g., classifications of planned routes being inaccessible) to the navigation system, predictions relating to informing a user of the vehicle (e.g., classifications of objects and other vehicles within the driving environment of the vehicle, classifications of operational states of the vehicle, etc.) to the user interface system, and so on. Multiple on-board sub-systems of the vehicle can therefore use the shared observation processing system to process observations of sensor data as part of performing respective processing tasks of the vehicle without requiring each sub-system to separately process the sensor data.

The described systems can therefore more efficiently process the sensor data to perform prediction tasks for the vehicle, e.g., with less memory consumption, processing time, energy consumption, and so on. Additionally, the vehicle sub-systems of the vehicle that provide queries to the described systems can be more easily trained and updated to perform respective processing tasks for the vehicle. As the other sub-systems of the vehicle can be updated to perform new processing tasks by providing appropriate queries to the shared observation processing system, rather than by being retrained to directly process sensor data, the observation processing system can allow the on-board systems of the vehicle to be updated to perform different processing tasks for the vehicle more efficiently than conventional systems (e.g., with less computational costs, training time, etc.).

In some implementations, the queries can include region proposals specifying arbitrarily shaped spatial regions of the observations of the sensor data and the described systems can be configured to generate predictions regarding the region proposals. This enables the described systems to efficiently generate predictions for prediction tasks regarding spatial regions of the observations associated with areas, objects, vehicles, and so on within the driving environment of the vehicle (e.g., as identified by performing object detection or segmentation).

In some implementations, the described systems can be configured to process observations of sensor data for the vehicle using multiple specialized processing networks. The multiple specialized processing networks can include processing networks with differing processing capabilities. For example, the specialized processing networks can include light-weight processing networks configured to perform less complex prediction tasks more quickly (e.g., with lower-latency) and larger processing networks configured to perform more complex prediction tasks that require more computational resources and time (e.g., compared to the prediction tasks performed by the light-weight processing networks. By using multiple specialized processing networks with differing processing capabilities, the described systems can use light-weight processing networks to perform short-term prediction tasks (e.g., prediction tasks relating to the immediate safety of the vehicle) more quickly and use larger processing networks to perform long-term prediction tasks (e.g., prediction tasks relating to long-term planning for the vehicle) more accurately (though with a longer processing latency compared to the short-term tasks).

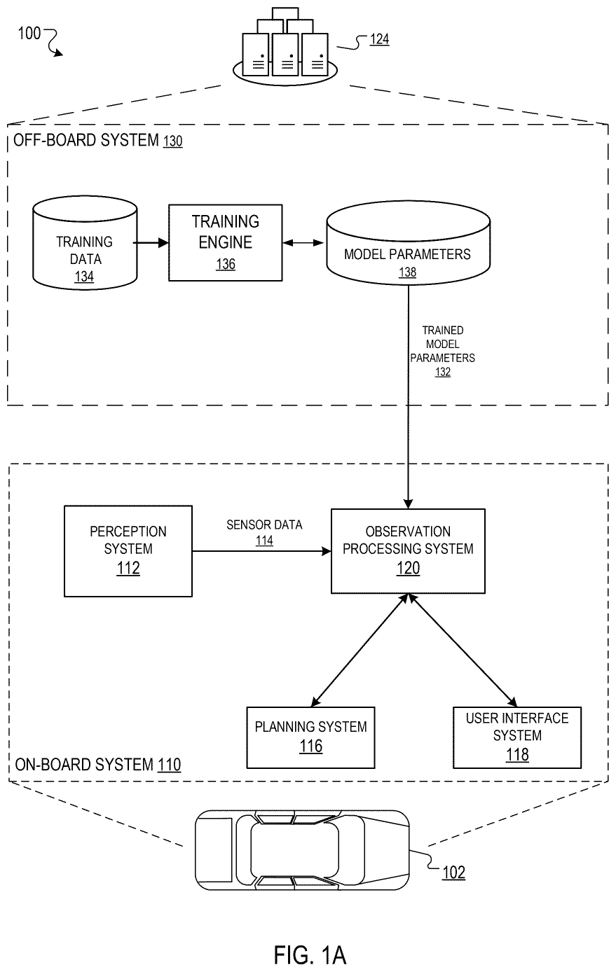

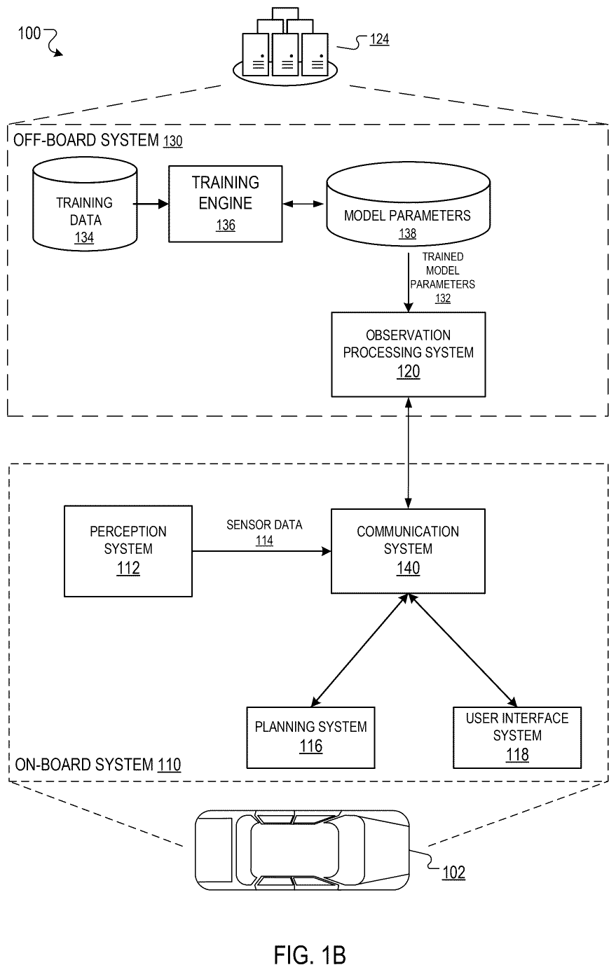

FIG. 1A illustrates an example vehicle sensor data processing task in which an on-board system 110 for a vehicle 102 processes sensor data for the vehicle 102 to generate predictions regarding an environment of the vehicle 102.

The on-board system 110 is located on-board the vehicle 102. The vehicle 102 in FIG. 1A is illustrated as an automobile, but the on-board system 110 can be located on-board any appropriate vehicle type.

In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver.

The on-board system 110 includes a perception system 112 that includes one or more sensors, some of which are configured to receive reflections of electromagnetic radiation from the environment in the vicinity of the vehicle 102. For example, the perception system 112 can include one or more laser sensors (e.g., LIDAR laser sensors) that are configured to detect reflections of laser light. As another example, the perception system 112 can include one or more radar sensors that are configured to detect reflections of radio waves. As another example, the perception system 112 can include one or more camera sensors that are configured to detect reflections of visible light.

The sensors of the perception system 112 continually (i.e., at each of multiple time points) capture observations of raw sensor data, which can indicate the directions, intensities, and distances travelled by reflected radiation. For example, a sensor in the perception system 112 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The perception system 112 can generate sensor data 114 that characterizes the observations captured by the sensors of the vehicle 102. The sensor data 114 characterizes a scene in an environment, e.g., an area of the environment that includes the area within a threshold distance of the autonomous vehicle or the area that is within range of at least one sensor of the vehicle.

In some examples, the sensor data 114 includes raw sensor data generated by one or more sensors from the perception system 112. In some examples, the sensor data 114 includes object detection data that has been generated from the outputs of an object detector that processes the observations of raw sensor data from the perception system 112. In some examples, the sensor data 114 includes segmentation data (e.g., image segmentation data, point-cloud segmentation data, etc.) that has been generated by performing segmentation of the observations of raw sensor data.

Generally, the sensor data 114 can include data for any of a plurality of sensor modalities of the perception system 112. For example, when the perception system 112 includes camera sensors, the sensor data 114 can include observations of image data obtained by the camera sensors of the vehicle 102. As another example, when the perception system 112 includes LIDAR sensors, the sensor data 114 can include observations of point-cloud data obtained by the LIDAR sensors of the vehicle 102. As another example, when the perception system 112 includes RADAR sensors, the sensor data can include observations of RADAR data obtained by the RADAR sensors of the vehicle 102.

The on-board system 110 can use an observation processing system 120 to generate predictions about the environment of the vehicle 102 by processing the sensor data 114 and data from other sub-systems of the vehicle 102 (e.g., a planning system 116 of the vehicle 102, a user interface system 118 of the vehicle, etc.). In particular, the observation processing system 120 can receive task data characterizing particular prediction tasks from other sub-systems of the vehicle 102 and can process the sensor data 114 and the task data to generate predictions for the particular prediction tasks.

The observation processing system 120 can be configured to generate any of a variety of predictions based on the sensor data 114. In particular, the observation processing system 120 can be configured to receive task data from other sub-systems of the vehicle 102 that includes classification labels for a particular prediction task and can generate classifications for the sensor data 114 using the received classification labels for the particular prediction task. For example, the task data can include classification labels for a state of the driving environment of the vehicle 102 (e.g., classification of whether the driving environment is safe, unsafe, obstructed, flooded, etc.). As another example, the task data can include classification labels for a state of the vehicle 102 (e.g., classification of whether the vehicle is operating safely, operating unsafely, damaged, operating unexpectedly, is experiencing a loss of control, is physically secure, etc.). As another example, the task data can include classification labels for other agents (e.g., vehicles, pedestrians, pedestrian gestures, objects, etc.) in the driving environment of the vehicle 102 (e.g., classifications of types of the agents, whether the agents are damaged, whether the agents are moving, whether the agents are merging, etc.).

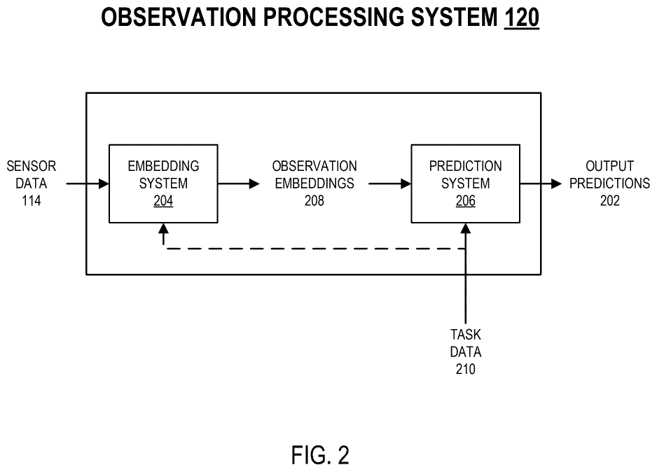

The observation processing system 120 and the predictions generated by the observation processing system 120 are described in further detail below with reference to FIG. 2.

The on-board system 110 can provide predictions generated by the observation processing system 120 to the other sub-systems of the vehicle (e.g., the planning system 116, the user interface system 118, etc.).

For example, when the planning system 116 receives predictions generated by the observation processing system 120, the planning system 116 can use the predictions generated by the observation processing system 120 to make fully-autonomous or partly-autonomous driving decisions. For example, the planning system 116 can generate a fully-autonomous plan to navigate the vehicle 102 to avoid a collision with another agent by changing the future trajectory of the vehicle 102 to avoid the predicted future trajectory of the agent. In a particular example, the on-board system 110 can provide the planning system 116 with predictions generated by the observation processing system 120 indicating that another vehicle which is attempting to merge onto a roadway being travelled by the vehicle 102 is unlikely to yield to the vehicle 102. In this example, the planning system 116 can generate fully-autonomous control outputs to apply the brakes of the vehicle 102 to avoid a collision with the merging vehicle. The fully-autonomous or partly-autonomous driving decisions generated by the planning system 116 can be implemented by a control system of the vehicle 102. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

As another example, when the user interface system 118 receives predictions generated by the observation processing system 120, the user interface system 118 can use the predictions generated by the observation processing system 120 to present information to the driver of the vehicle 102 to assist the driver in operating the vehicle 102 safely. The user interface system 118 can present information to the driver of the vehicle 102 by any appropriate means, for example, by an audio message transmitted through a speaker system of the vehicle 102 or by alerts displayed on a visual display system in the vehicle (e.g., an LCD display on the dashboard of the vehicle 102). In a particular example, the on-board system 110 can provide the user interface system 118 with trajectory prediction output indicating that another vehicle which is attempting to merge onto a roadway being travelled by the vehicle 102 is unlikely to yield to the vehicle 102. In this example, the user interface system 118 can present an alert message to the driver of the vehicle 102 with instructions to adjust the trajectory of the vehicle 102 to avoid a collision with the merging vehicle.

The observation processing system 120 can include one or more predictive machine learning models configured to process the sensor data 114 and generate predictions regarding the environment of the vehicle 102.

Prior to the on-board system 110 using the observation processing system 120 to make predictions, a training system 130 can determine trained model parameters 132 for the observation processing machine learning models of the system 120.

The training system 130 is typically hosted within a data center 124, which can be a distributed computing system having hundreds or thousands of computers in one or more locations.

The training system 130 can train observation processing machine learning models for the observation processing system 120 using training data 134 of the system 130. The training data 134 generally includes example data characterizing example environments for example vehicles. The training data 134 can be obtained from real or simulated driving data logs.

As an example, the training data 134 can include example data for the one or more sensor data modalities (e.g., images, point-clouds, etc.) representing raw sensor data. The training data 134 can include example task data characterizing example prediction tasks for the training data 134.

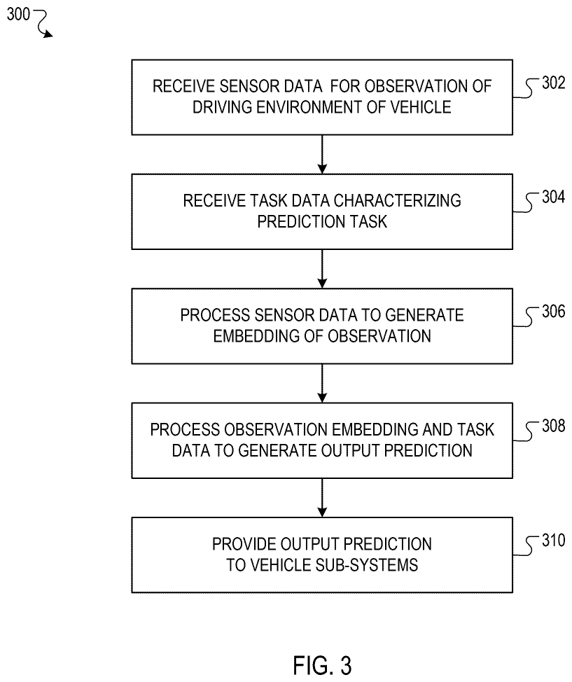

The training engine 136 trains the observation processing machine learning models for the observation processing system 120 to update model parameters 138 by optimizing an objective function based on target predictions for the training data 134, e.g., an objective function that measures a similarity between output predictions generated by the observation processing system 120 and corresponding target predictions, as described in more detail below with reference to FIG. 3.

After training observation processing machine learning models, the training system 130 can send the trained model parameters 132 to the observation processing system 120, e.g., through a wired or wireless connection.

In some implementations, the driving environment can be a simulated driving environment and the vehicle 102 can be a simulated vehicle navigating the simulated driving environment. The simulated driving environment can represent a real-world driving environment and the observation processing system 120 can generate predictions for simulating the real-world driving environment. For example, the observation processing system 120 can receive input data specifying a simulated scenario for the vehicle 102 and can generate predictions for the simulated driving scenario, such as trajectories for objects in the simulated scenario, sensor data for the vehicle 102 in the simulated scenario, and so on.

While this specification describes processing sensor data and generating predictions on-board an autonomous vehicle, more generally, the described techniques can be implemented on any system of one or more computers that receives images of scenes in an environment. That is, once the training system 130 has trained the observation processing system 120, the observation processing system 120 can be used by any system of one or more computers.

As one example, the observation processing system 120 can be a part of an on-board system 110 for a different type of agent that has sensors and that interacts with objects as it navigates through an environment. For example, the observation processing system 120 can process sensor data and generate predictions for a robot or other agent.

As another example, the observation processing system 120 can be a part of an off-board system 130 that is remote from the agent and that receives data generated by sensors and navigation systems (e.g., planning systems) of the agent. When the observation processing system 120 is part of an off-board system 130, the off-board system 130 can generate responses to queries for the agent (e.g., queries transmitted to the off-board system by the on-board system 110 for the agent) and can transmit the generated responses to the on-board system 110. The on-board system 110 can process the responses transmitted by the off-board system 130 to control the agent.

FIG. 1B illustrates an example vehicle sensor data processing task in which the off-board system 130 includes the observation processing system 120 and processes sensor data for the vehicle 102 to generate predictions regarding the environment of the vehicle 102.

As illustrated in FIG. 1B, the observation processing system 120 can be located on one or more computers that are remote from the vehicle 102 (e.g., within the data center 124) and can receive data as transmitted by the vehicle 102, e.g., as transmitted by a communication system 140 of the vehicle 102. The observation processing system 120 can process, e.g., sensor data 114 obtained by the perception system 112, data generated by the planning system 116, user inputs obtained by the user interface system 118, and so on, transmitted by the communication system 140 of the vehicle 102 to the system 120 in order to generate a prediction of the driving environment for the vehicle 102. The system 120 can then transmit the generated prediction to the vehicle 102, e.g., for use in performing fully-autonomous or semi-autonomous driving tasks.

As an example, the observation processing system 120 can monitor data transmitted by the vehicle 102 and detect potentially unsafe situations. When the observation processing system 120 detects an unsafe situation, the system 120 can transmit data to an ADAS system of the vehicle 102 that can then alert a human driver of the vehicle. As another example, the observation processing system 120 can process sensor data and task data for a navigation task transmitted by the vehicle 102 and can transmit the planned trajectory to the vehicle 102 for use in navigation planning by sub-systems (e.g., the planning system 116) of the vehicle 102.

When the observation processing system 120 is located on one or more computers that are remote from the vehicle 102, the system 120 can receive and process data generated by sources other than sensors and systems of the vehicle 102 as part of generating predictions for the vehicle 102. For example, the observation processing system 120 can receive and process sensor data obtained by sensors outside the vehicle 102 that are observing the driving environment of the vehicle 102. As another example, the observation processing system 120 can receive and process sensor data and navigation data transmitted to the system 120 by other vehicles in the driving environment of the vehicle 102. By processing data from sources other than systems of the vehicle 102, the observation processing system 120 can transmit information to the vehicle 102 that may otherwise be unavailable to the vehicle 102. As a further example, if a portion of the driving environment is obstructed from the view of sensors on-board the vehicle 102, the observation processing system 120 can transmit predictions to the vehicle 102 that can provide information to the vehicle 102 about the obstructed portion of the driving environment.

FIG. 2 is a block diagram for an example observation processing system 120. The observation processing system 120 is an example of a system implemented as computer programs on one or more computers in one or more locations in which the systems, components, and techniques described below are implemented.

As described above the observation processing system 120 can process sensor data 114 to generate an output prediction 202 regarding a driving environment of a vehicle.

The sensor data 114 can include observations of the driving environment of the vehicle for any of a variety of sensors of the vehicle. For example, the sensor data 114 can include observations of, e.g., image data obtained by camera sensors of the vehicle, point-cloud data obtained by LIDAR sensors of the vehicle, RADAR data obtained by the RADAR sensors of the vehicle, and so on.

The observation processing system 120 can be configured to generate any of a variety of output predictions 202 based on the sensor data 114. For example, the output predictions can predictions regarding a state of the driving environment of the vehicle (e.g., classifications of whether the driving environment is safe, unsafe, obstructed, flooded, etc.), regarding states of regions of the driving environment of the vehicle (e.g., classifications of whether the regions are safe to enter, unsafe to enter, obstructed, flooded, etc.), regarding a state of the vehicle (e.g., classification of whether the vehicle is operating safely, operating unsafely, damaged, operating unexpectedly, is experiencing a loss of control, is physically secure, etc.), regarding state of other agents (e.g., vehicles, pedestrians, pedestrian gestures, objects, etc.) in the driving environment of the vehicle (e.g., classifications of types of the agents, whether the agents are damaged, whether the agents are moving, whether the agents are merging, etc.).

The observation processing system 120 can provide the generated output predictions 202 to other sub-systems of the vehicle for use in performing any of a variety of tasks. For example, the system 120 can provide the output predictions 202 to a planning system of the vehicle for use in generating navigation plans for the vehicle, determining planned control inputs for the vehicle, and so on. As another example, the system 120 can provide the output predictions 202 to a user interface system of the vehicle for use in, e.g., providing information to a user of the vehicle regarding the driving environment of the vehicle, warning a user of the vehicle about unsafe driving conditions, and so on.

The observation processing system 120 can include an embedding system 204 and a prediction system 206, which are described next (and throughout this specification).

The embedding system 204 can process the sensor data 114 to generate observation embeddings 208 representing the one or more observations of the sensor data 114. Each of the observation embeddings 208 for an observation of the sensor data 114 can include a plurality of numerical features that represent the observation. As an example, each of the observation embeddings 208 can be a vector of numerical features representing a respective observation of the sensor data 114. As another example, each of the observation embeddings 208 can include multiple vectors of numerical features representing a respective observation of the sensor data 114. For example, each observation embedding can be a sequence of tokens, wherein each token is a vector of numerical features representing a respective portion of the observation of the sensor data 114 for the observation embedding.

The embedding system 204 can include any combination of embedding neural networks configured (e.g., trained) to process the sensor data 114 to generate the observation embeddings 208. The embedding neural networks can include any of a variety of processing layers (e.g., convolutional layers, graph processing layers, recurrent layers, attention layers, and so on) for processing some or all of the sensor data 114 to generate respective observation embeddings 208.

In particular, the embedding system 204 can include embedding neural networks for each of one or more of the sensor modalities of the vehicle. For example, the embedding system 204 can include image embedding neural networks configured to generate observation embeddings 208 for observations of image data obtained by camera sensors of the vehicle, LIDAR embedding neural networks configured to generate observation embeddings 208 for observations of point-cloud data obtained by LIDAR sensors of the vehicle, RADAR embedding neural networks configured to generate observation embeddings 208 for observations of RADAR data obtained by RADAR sensors of the vehicle, and so on.

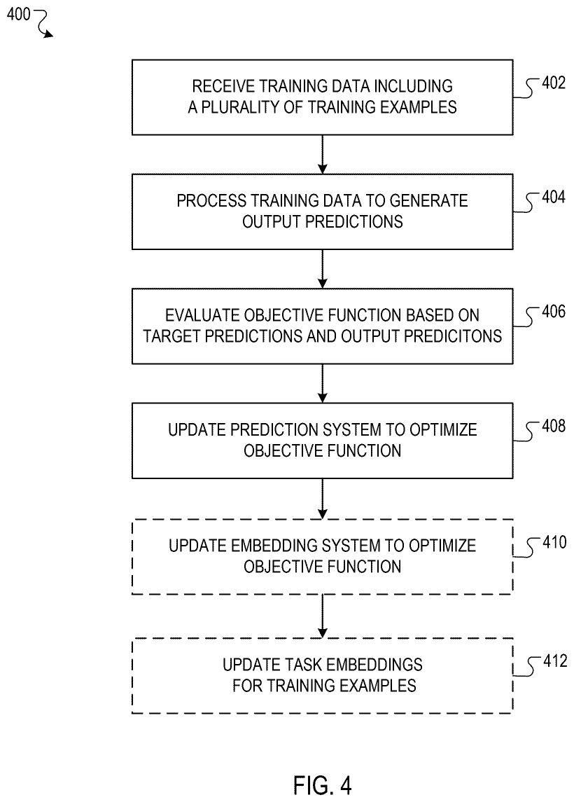

Some or all of the embedding neural networks can be neural networks that have been trained (e.g., pre-trained) to perform different processing tasks before being trained to generate observation embeddings for particular sensor modalities. For example, some or all of the embedding neural networks can be vision encoding neural networks for, e.g., a language model, a vision language model, and so on that are further trained (e.g., following the process 400 of FIG. 4) to generate observation embeddings for particular sensor modalities. As another example, some or all of the embedding neural networks can be distillations of vision encoding neural networks for, e.g., a language model, a vision language model, and so on, that are further trained (e.g., following the process 400 of FIG. 4) to generate observation embeddings for the particular sensor modalities.

In some implementations, the embedding system 204 can receive (e.g., from another sub-system of the vehicle, such as a planning system of the vehicle, a user interface system of the vehicle, and so on) task data 210 that characterizes a particular prediction task. The embedding system 204 can generate task-specific observation embeddings 208 for the particular prediction task. For example, the embedding system 204 can include projection neural networks for each of a plurality of prediction tasks. The projection neural networks can include any of a variety of processing layers (e.g., convolutional layers, graph processing layers, recurrent layers, attention layers, and so on) for processing initial observation embeddings (e.g., as generated by embedding neural networks of the embedding system 204) to generate task-specific observation embeddings 208. When the embedding system 204 generates an initial observation embedding using an embedding neural network, the embedding system 204 can select a projection neural network for a particular prediction task (e.g., a projection neural network specified by the task data 210) and can generate a task specific observation embedding for the particular prediction task by processing the initial observation embedding using the selected projection neural network.

The prediction system 206 can process the observation embeddings 208 to generate the output prediction 202. The prediction system 206 can receive (e.g., from the other sub-system of the vehicle) the task data 210 that characterizes a particular prediction task.

In particular, the task data 210 can characterize classification labels for the particular prediction task. For example, the task data 210 can characterize classification labels for a state of the driving environment of the vehicle (e.g., classification of whether the driving environment is safe, unsafe, obstructed, flooded, etc.). As another example, the task data 210 can characterize classification labels for a state of regions of the driving environment of the vehicle (e.g., classification of whether the regions are safe to enter, unsafe to enter, obstructed, flooded, etc.). As another example, the task data 210 can characterize classification labels for a state of the vehicle (e.g., classification of whether the vehicle is operating safely, operating unsafely, damaged, operating unexpectedly, is experiencing a loss of control, is physically secure, etc.). As another example, the task data 210 can characterize classification labels for other agents (e.g., vehicles, pedestrians, pedestrian gestures, objects, etc.) in the driving environment of the vehicle (e.g., classifications of types of the agents, whether the agents are damaged, whether the agents are moving, whether the agents are merging, etc.).

The task data 210 can include task embeddings representing predictions for the particular prediction task. For example, when the particular prediction task is a classification task, each task embedding can represent a classification label for the classification task. The other sub-system of the vehicle can produce the task embeddings for the particular prediction task by any of a variety of means.

As an example, task embeddings can be machine-learned parameters (e.g., machine learned vectors) stored by the other sub-system of the vehicle for the particular prediction task. For example, when the particular prediction task is a classification task, the task embeddings can be machine learned embeddings for class labels of the classification task stored by the other sub-system of the vehicle.

As another example, the other sub-system of the vehicle can generate the task embeddings for the particular prediction task using a text embedding neural network. For example, when the particular prediction task is a classification task, the system can process text prompts that include classification labels for the classification task using a language model to generate output token sequences representing the classification labels for the classification task. The text prompts for the language model of the other sub-system of the vehicle can include, e.g., classification labels for states of the driving environment of the vehicle (e.g., “safe”, “unsafe”, “obstructed”, “flooded”, etc.), classification labels for states of regions of the driving environment of the vehicle (e.g., “safe to enter”, “unsafe to enter”, “obstructed”, “flooded”, etc.), classification labels for states of the vehicle (e.g., “operating safely”, “operating unsafely”, “damaged”, “operating unexpectedly”, “loss of control”, “physically secure”, etc.), classification labels for types of other agents in the driving environment of the vehicle (e.g., “passenger vehicle”, “emergency vehicle”, “sedan”, “truck”, “bicycle”, “pedestrian”, “obstruction”, etc.), classification labels for states of other agents in the driving environment of the vehicle (e.g., “damaged”, “moving”, “merging”, etc.), and so on. The other sub-system can generate the task embeddings for the classification task using the output token sequences representing the classification labels for the classification task, e.g., by outputting tokens of the output token sequences as the task embeddings, by processing the output token sequences using a token processing neural network to generate the task embeddings, and so on.

When the other sub-system of the vehicle generates the task embeddings for the particular prediction task using a text embedding neural network, the other system can pre-compute and store (e.g., cache) the generated task embeddings. By pre-computing and storing the task embeddings, the other sub-system can produce the task data 210 for the particular prediction task without, e.g., re-processing prompts using the text embedding neural network to generate the task embeddings representing predictions for the particular prediction task.

In some implementations, the text embedding neural network can be an off-board text embedding neural network and the other sub-system of the vehicle can receive and store (e.g., cache) the text embeddings as pre-computed by the off-board text embedding neural network. Generating the task embeddings using the off-board text embedding neural network enables the on-board sub-systems of the vehicle to use task embeddings generated by processing corresponding text prompts without storing an on-board text embedding neural network, which can reduce the complexity and computational costs of the on-board sub-systems of the vehicle.

The text embedding neural network can be a neural network that has been trained (e.g., pre-trained) to perform a different processing task before being trained to generate task embeddings for particular prediction tasks. For example, the text embedding neural network can be a text processing neural network of, e.g., a language model, a vision language model, and so on that is further trained (e.g., following the process 400 of FIG. 4) to generate task embeddings for particular prediction tasks. As another example, the text embedding neural network can be a distillation of a text processing neural networks of, e.g., a language model, a vision language model, and so on, that is further trained (e.g., following the process 400 of FIG. 4) to generate task embeddings for particular prediction tasks.

In some implementations, the task data 210 can characterize multiple prediction tasks for the same observation of sensor data 114 (e.g., include task embeddings for multiple prediction tasks).

When the prediction system 206 receives task data 210 characterizing a particular prediction task, the prediction system 206 can process the observation embeddings 208 and the task data 210 to generate the output prediction 202 for the particular task and for the observations characterized by the sensor data 114. When task data 210 can characterize multiple prediction tasks, the prediction system 206 can process the observation embeddings 208 and the task data 210 to generate a corresponding output prediction 202 for each of the prediction tasks characterized by the task data 210.

For example, the prediction system 206 can be configured to process the observation embeddings 208 and the task data 210 to determine, for each pair of an observation embedding and classification label characterized by the task data 210, a similarity score that characterizes a likelihood that the observation embedding is associated with the classification label. For each of the observation embeddings 208, the prediction system 206 can generate a prediction output 202 for the observation embedding that specifies, e.g., the determined similarity scores of the classification labels for the observation embedding, the classification label determined to have the highest similarity score for the observation embedding, and so on.

As another example, the prediction system 206 can include any combination of prediction neural networks configured to process the observation embeddings 208 and the task data 210 to generate the output predictions 202. The prediction neural networks can include any of a variety of processing layers (e.g., convolutional layers, graph processing layers, recurrent layers, attention layers, and so on) for processing some or all of the observation embeddings 208 and some or all of the task data 210 to generate respective output predictions 202.

As an example, the prediction system 206 can include a language model (e.g., a vision language model) configured to process a token sequence that includes the observation embeddings 208 and embeddings of the task data 210 to generate an output token sequence characterizing the output predictions 202.

An example process for generating the output prediction 202 using the observation processing system 120 is described in more detail below with reference to FIG. 3. Training the one or more neural networks of the prediction system 206 is described in more detail below with reference to FIG. 4.

By processing task embeddings for prediction tasks as part of generating the output predictions 202, the observation processing system 120 can generate the output predictions 202 for multiple on-board sub-systems of the vehicle to perform a variety of prediction tasks for the vehicle. For example, by receiving appropriately configured task embeddings from a navigation system and a user interface of the vehicle, the same observation processing system 120 can provide output predictions 202 relating to the immediate safety of the vehicle (e.g., classifications of hazards to the vehicle within the driving environment, classifications of an operational safety of the vehicle, etc.) to the navigation system, output predictions 202 relating to long-term navigational planning (e.g., classifications of planned routes being inaccessible) to the navigation system, output predictions 202 relating to informing a user of the vehicle (e.g., classifications of objects and other vehicles within the driving environment of the vehicle, classifications of operational states of the vehicle, etc.) to the user interface system, and so on. Multiple on-board sub-systems of the vehicle can therefore use the same observation processing system 120 to process the sensor data 114 as part of performing respective processing tasks of the vehicle without requiring each sub-system to independently process the sensor data 114.

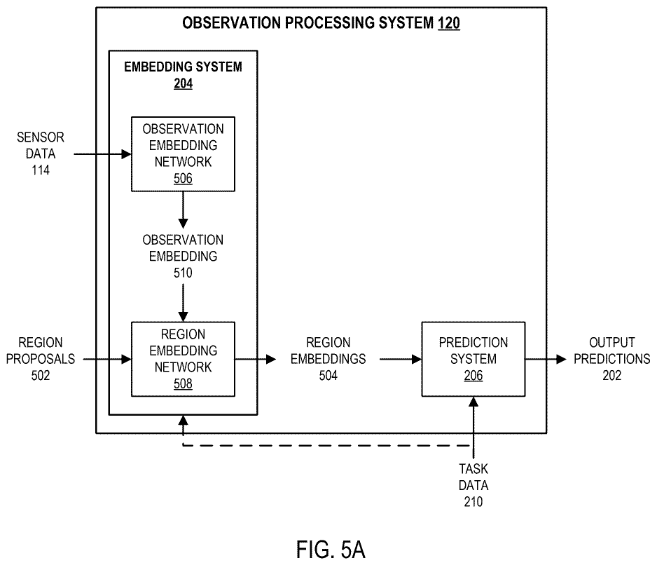

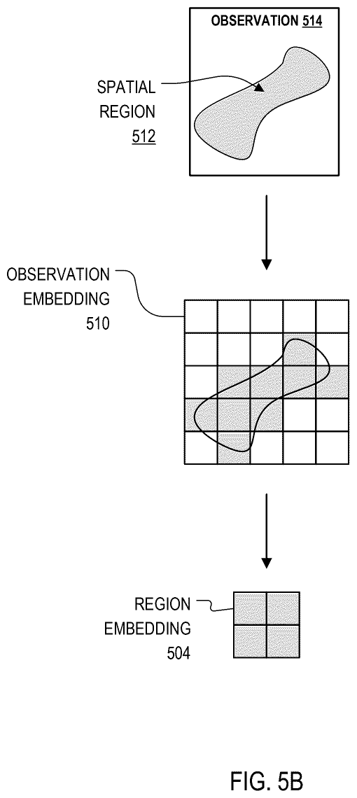

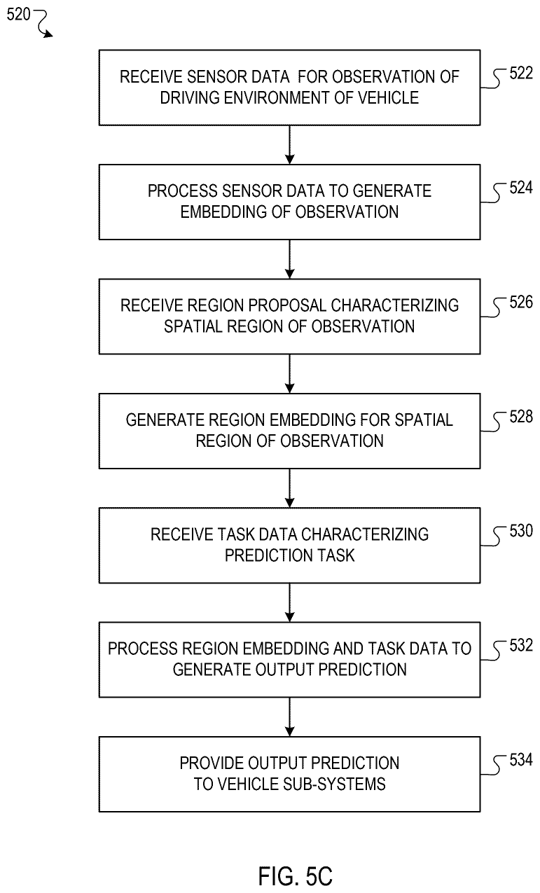

In some implementations, the task data 210 can include region proposals characterizing specific spatial regions of the observations of the sensor data 114 (e.g., spatial regions of the observations associated with areas, objects, vehicles, and so on within the driving environment of the vehicle). The observation processing system 120 can be configured to process the sensor data 114 and the region proposals to generate the output predictions 202 for the specific spatial regions specified by the task data 210. Processing the sensor data 114 and the task data 210 to generate output predictions 202 regarding region proposals for the observations of the sensor data 114 is described in more detail below with reference to FIGS. 5A, 5B, and 5C.

In some implementations, the observation processing system 120 can be configured to process sensor data 114 characterizing a sequence of observations of the driving environment to generate output predictions 202 using multiple specialized processing networks. Each of the specialized processing neural networks can be specialized to process, e.g., a respective subset of the observations of sensor data 114, a respective subset of the task data 210, and so on.

The multiple specialized processing networks can include processing networks with differing processing capabilities. For example, the specialized processing networks can include light-weight processing networks configured to perform less complex prediction tasks more quickly (e.g., with lower-latency) and larger processing networks configured to perform more complex prediction tasks that require more computational resources and time (e.g., compared to the prediction tasks performed by the light-weight processing networks. By using multiple specialized processing networks with differing processing capabilities, the observation processing system 120 can use light-weight processing networks to perform short-term prediction tasks (e.g., prediction tasks relating to the immediate safety of the vehicle) more quickly and use larger processing networks to perform long-term prediction tasks (e.g., prediction tasks relating to long-term planning for the vehicle) more accurately (though with a longer processing latency compared to the short-term tasks).

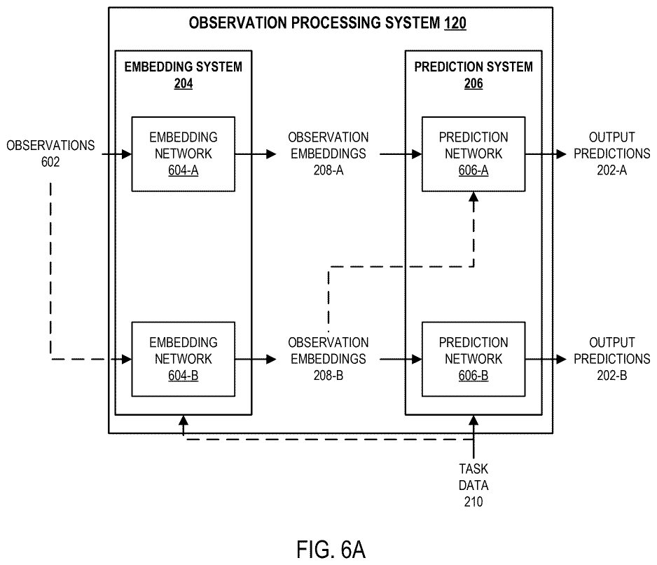

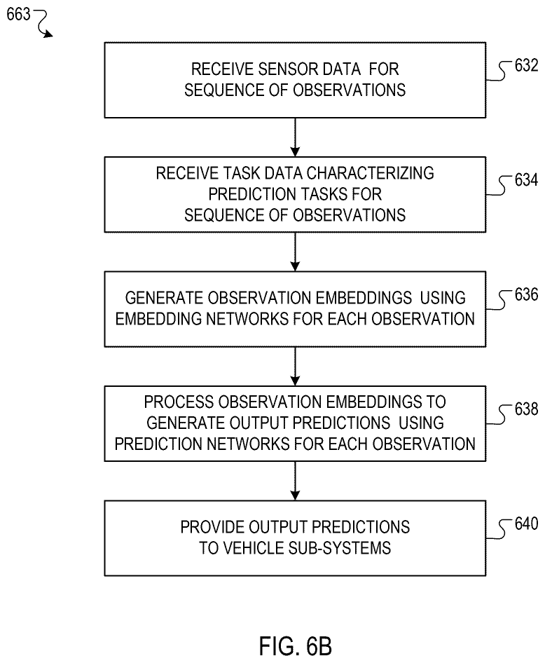

Processing sensor data 114 characterizing a sequence of observations of the driving environment to generate output predictions 202 using multiple specialized processing networks is described in more detail below with reference to FIG. 6A and FIG. 6B.

FIG. 3 is a flow diagram of an example process 300 for generating a prediction for a particular prediction task by processing sensor data for a vehicle in a driving environment. For convenience, the process 300 will be described as being performed by a system of one or more computers located in one or more locations. For example, an observation processing system of a vehicle, e.g., the observation processing system 120 of FIG. 1A, appropriately programmed in accordance with this specification, can perform the process 300.

The system can receive sensor data that characterizes one or more observations of the driving environment of the vehicle as obtained by sensors of the vehicle (step 302). For example, the sensor data can include one or more observations of, e.g., image data obtained by camera sensors of the vehicle, point-cloud data obtained by LIDAR sensors of the vehicle, RADAR data obtained by the RADAR sensors of the vehicle, and so on.

The system can receive the sensor data as generated by a perception system of the vehicle.

The system can receive task data that characterizes the particular prediction task (step 304). The system can receive the task data from another sub-system of the vehicle (e.g., a navigation system of the vehicle, a user interface system of the vehicle, etc.). The task data characterizing the particular prediction task can include one or more task embeddings for the particular prediction task. Each task embedding for the particular prediction task can represent a corresponding prediction for the prediction task.

The other sub-system of the vehicle can produce the task embeddings for the particular prediction task by any of a variety of means. As an example, task embeddings can be machine-learned parameters (e.g., machine learned vectors) stored by the other sub-system of the vehicle for the particular prediction task. For example, when the particular prediction task is a classification task, the task embeddings can be machine learned embeddings for class labels of the classification task stored by the other sub-system of the vehicle.

As another example, the other sub-system of the vehicle can generate the task embeddings for the particular prediction task using a text embedding neural network. For example, when the particular prediction task is a classification task, the system can process text prompts that include classification labels for the classification task using a language model to generate output token sequences representing the classification labels for the classification task. The other sub-system can generate the task embeddings for the classification task using the output token sequences representing the classification labels for the classification task, e.g., by outputting tokens of the output token sequences as the task embeddings, by processing the output token sequences using a token processing neural network to generate the task embeddings, and so on.

When the other sub-system of the vehicle generates the task embeddings for the particular prediction task using a text embedding neural network, the other system can pre-compute and store (e.g., cache) the generated task embeddings. In some implementations, the text embedding neural network can be an off-board text embedding neural network and the other sub-system of the vehicle can receive and store (e.g., cache) the text embeddings as pre-computed by the off-board text embedding neural network. The other sub-system of the vehicle can produce the task data for the particular prediction task by retrieving the pre-computed task embeddings for the particular prediction task.

In some implementations, as described in more detail below with reference to FIG. 4, the system can be jointly trained with the other sub-system to perform the particular prediction task.

In some implementations, the task data can include region proposals characterizing specific spatial regions of the observations (e.g., spatial regions of the observations associated with areas, objects, vehicles, and so on within the driving environment of the vehicle).

The system can process the received sensor data to generate embeddings for the one or more observations characterized by the sensor data (step 306). In particular, the system can process the received sensor data using one or more embedding neural networks configured to process the sensor data to generate the observation embeddings. The one or more embedding neural networks can include any of a variety of processing layers (e.g., convolutional layers, graph processing layers, recurrent layers, attention layers, and so on) for processing some or all of the sensor data to generate respective observation embeddings.

The system can process the received sensor data using embedding neural networks for each of the sensor modalities of the vehicle. For example, the system can process the sensor data using, e.g., image embedding neural networks configured to generate observation embeddings for observations of image data obtained by camera sensors of the vehicle, LIDAR embedding neural networks configured to generate observation embeddings for observations of point-cloud data obtained by LIDAR sensors of the vehicle, RADAR embedding neural networks configured to generate observation embeddings for observations of RADAR data obtained by RADAR sensors of the vehicle, and so on.

As an example, embedding neural networks can include an image embedding neural network that includes a plurality of convolutional processing layers. The image embedding neural network can generate observation embeddings for observations of image data by processing the image data using the convolutional processing layers.

As another example, the embedding neural networks can include a LIDAR embedding neural network that includes a plurality of graph processing layers. The LIDAR embedding neural network can process an input graph representing an observation of a point-cloud of LIDAR data (e.g., an input graph that includes a respective graph node characterizing each point in the point-cloud) using the plurality of graph processing layers to generate an observation embedding for the point-cloud of LIDAR data. For example, the LIDAR embedding neural network can be configured to perform a sequence of message passing operations using the graph processing layers to process the input graph and generate the observation embedding for the observation of point-cloud LIDAR data.

As another example, the embedding neural networks can include one or more token processing neural networks configured to process input token sequences representing observations of sensor data to generate output token sequences that include observation embeddings for the observations of sensor data. The token processing neural networks can include attention network layers configured to perform respective attention operations as part of processing the input token sequences to generate the output token sequences. For example, a token processing neural network for generating observation embeddings of image data can be configured to process input token sequences representing observations of image data (e.g., input token sequences that include tokens representing pixels, groups of pixels, etc.) to generate output token sequences that include observation embeddings for the observations of image data. As another example, a token processing neural network for generating observation embeddings of point-cloud LIDAR data can be configured to process input token sequences representing observations of point-cloud LIDAR data (e.g., input token sequences that include tokens representing respective points within the LIDAR point-clouds) to generate output token sequences that include observation embeddings for the observations of point-cloud LIDAR data. As another example, a token processing neural network for generating observation embeddings of RADAR data can be configured to process input token sequences representing observations of RADAR data (e.g., input token sequences that include tokens representing respective RADAR signal return strengths) to generate output token sequences that include observation embeddings for the observations of RADAR data.

In some implementations, the system can generate task-specific observation embeddings for the particular prediction task specified by the task data. For example, the system can include projection neural networks for each of a plurality of prediction tasks. The projection neural networks can include any of a variety of processing layers (e.g., convolutional layers, graph processing layers, recurrent layers, attention layers, and so on) for processing initial observation embeddings (e.g., as generated by embedding neural networks of the system) to generate task-specific observation embeddings. When the system generates an initial observation embedding using an embedding neural network, the system can select a projection neural network for the particular prediction task (e.g., a projection neural network specified by the received task data) and can generate a task specific observation embedding for the particular prediction task by processing the initial observation embedding using the selected projection neural network.

When the received task data includes region proposals specifying spatial regions of the observations, the system can process the observation embeddings and the region proposals to region embeddings characterizing the spatial regions of the observations specified by the region proposals. Processing the observation embeddings and the region proposals to generate region embeddings for the region proposals is described in more detail below with reference to FIGS. 5A, 5B, and 5C.

The system can process the sensor data to generate the observation embeddings using multiple specialized embedding neural networks. Each of the specialized embedding neural networks can, e.g., have a respective specialized network architecture, process a respective subset of the observations of sensor data, and so on. Processing the sensor data using multiple specialized embedding neural networks is described in more detail below with reference to FIG. 6A and FIG. 6B.

The system can process the received task data and the generated observation embeddings to generate an output prediction for the particular prediction task (step 308). The system can process the task data and the generated observation embeddings using a prediction system configured to process the observation embeddings and the task data to generate the prediction output.

For example, when the task data includes task embeddings representing classification labels for the particular prediction task, the prediction system can process the observation embeddings and the task embeddings for the classification labels to determine, for each pair of an observation embedding and a task embedding, a similarity score between the observation embedding and the task embedding.

As an example, the prediction system can determine the similarity score, S(x, z) between an observation embedding, x, and a task embedding, z, following:

$$S ( {x}_{x} z ) = x \cdot z$$

As another example, the prediction system can determine the similarity score, S(x, z) between an observation embedding, x, and a task embedding, z, following:

$$S ( x , z ) = {f}_{θ}^{T} ( x ) {W}_{{g}_{θ}} ( z )$$

Where ƒ_{θ} and g_{θ} are machine-learned vector functions (e.g., as parameterized by respective neural networks) and W is a machine learned matrix.

For each observation embedding and task embedding, the similarity score between the observation embedding and the task embedding can characterize a likelihood that the observation embedding is associated with the classification label for the task embedding. The prediction system can generate the prediction output to include, e.g., the determined similarity scores of the classification labels for each of the observation embeddings, the classification labels determined to have the highest similarity scores for each of the observation embedding, and so on.

As another example, the prediction system can include a prediction neural network configured to process the observation embeddings and the task data to generate the prediction output. The prediction neural network can include any of a variety of processing layers (e.g., convolutional layers, graph processing layers, recurrent layers, attention layers, and so on) for processing the observation embeddings and the task data to generate the output prediction.

The prediction neural network can be trained using to process the task data and the observation embedding using any appropriate machine learning technique. An example process for training the prediction network is described in more detail below with reference to FIG. 4.

As an example, the prediction system can process the task data and the generated observation embeddings using a language model (e.g., a vision language model) configured to process an input token sequence that includes the observation embeddings and embeddings of the task data to generate an output token sequence characterizing the output prediction.

When the system receives region proposals for the observations and generates region embeddings for the region proposals, the system can process the region embeddings to generate output predictions for the particular prediction task for each of the spatial regions specified by the received region proposals. Processing region embeddings for region proposals to generate output predictions for the spatial regions of the observations specified by the region proposals is described in more detail below with reference to FIGS. 5A, 5B, and 5C.

The system can process the observation embeddings and task data to generate output predictions using multiple specialized prediction neural networks. Each of the specialized prediction neural networks can, e.g., have a respective specialized network architecture, process a respective subset of the observation embeddings, process a respective subset of the task data, and so on. Processing the observation embeddings and task data using multiple specialized prediction neural networks is described in more detail below with reference to FIG. 6A, and FIG. 6B.

The system can provide the generated output prediction for processing by other sub-systems of the vehicle (step 310). The other sub-systems of the vehicle can process the output prediction to perform any of a variety of tasks for the vehicle. For example, the system can provide the generated output prediction to a planning system of the vehicle that can process the prediction to determine one or more planned control inputs for the vehicle. The planned control inputs can be used to control the vehicle (e.g., to perform a navigation task for the vehicle within the driving environment for the vehicle). As another example, the system can provide the output predictions to a user interface system of the vehicle that can, e.g., provide information to a user of the vehicle regarding the driving environment of the vehicle based on the output prediction, warn a user of the vehicle about unsafe driving conditions based on the output prediction, and so on.

FIG. 4 is a flow diagram of an example process for training an observation processing system. For convenience, the process 400 will be described as being performed by a system of one or more computers located in one or more locations. For example, an observation processing system of a vehicle, e.g., the observation processing system 120 of FIG. 1A, appropriately programmed in accordance with this specification, can perform the process 400.

The system can receive training data that includes a plurality of training examples for the observation processing system (step 402). Each training example can include: (i) an example observation for the training example, (ii) example task embeddings for a prediction task for the training example, and (iii) a target prediction for prediction task for the training example. The training data can include training examples for a plurality of prediction tasks. In some implementations, the observation processing system can include one or more projection neural networks configured to generate task specific observation embeddings for respective prediction tasks and each training example can include data specifying a projection neural network to be used for the training example. In some implementations, the observation processing system can be configured to generate output predictions regarding specific spatial regions of a driving environment of a vehicle and each training example can include an example region proposal for the training example.

As described in more detail above with reference to FIG. 2 and FIG. 3, the example task embeddings for the plurality of training examples can be generated by another sub-system of the vehicle (e.g., by a navigation system of the vehicle, a user interface system of the vehicle, etc.). For example, the example task embeddings can be machine-learned parameters (e.g., machine learned vectors) stored by the other sub-system of the vehicle. As another example, the other sub-system of the vehicle can generate the example task embeddings by processing corresponding text prompts using a text embedding neural network (e.g., using a language model).

The system can process the example observation for the training example and the example task embeddings for the training example to generate an output prediction for each training example (step 404). For example, the system can generate the output prediction for generate an output prediction for each training example using an embedding system and a prediction system of the observation processing system following the process 300 described in more detail above with reference to FIG. 3. When a training example includes data specifying a projection neural network to be used for the training example, the system can generate a task-specific observation embedding for the training example using the specified projection neural network as part of generating the output prediction for the training example.

In some implementations, when the task data includes task embeddings, the system can determine a similarity score for each example observation and for each task embedding that characterizes a likelihood that the observation is associated with the prediction (e.g., classification label) associated with the task embedding.

When the training example includes a region proposal for the training example, the system can generate the output predictions regarding a specific spatial region of a driving environment specified by the region proposal, as described in more detail below with reference to FIGS. 5A, 5B, and 5C.

In some implementations, the observation processing system can include multiple specialized networks and the system can process example observations for the training examples using the multiple specialized neural networks to generate the output predictions for the training examples, as described in more detail below with reference to FIGS. 6A and 6B.

The system can evaluate an objective function for the observation processing system based on the output and target predictions for the training examples (step 406). The objective function can be any appropriate objective function for the prediction tasks of the training examples. In particular, the objective function can, for each training example, measure an agreement between the output predictions and corresponding target predictions for the training examples.

For example, when the prediction tasks are classification tasks, the objective function can be a cross-entropy loss between output classification labels and target classification labels for the training examples.

As another example, when the observation processing system determines similarity scores for each example observation and task embedding of the training examples, the objective function can include a contrastive loss determined using the similarity scores between the observations and the task embeddings.

For each example observation, training examples can include a “positive” task embedding associated with the example observation (e.g., a task embedding representing a correct prediction or classification for the example observation) and one or more “negative” task embeddings that are not associated with the example observation. As an example, each negative task embedding for an example observation can be a task embedding representing an incorrect prediction or classification for the example observation. As another example, the system can train the observation processing system using batches of training examples and the negative task embeddings for each example observation from a given batch of training examples can be the positive task embeddings representing correct predictions or classifications for the other example observation from the given batch of training examples.

When the task embeddings for the training examples are generated by processing corresponding text prompts using a text embedding neural network, the positive task embedding for each example observation can be generated by the text embedding neural network processing a text prompt describing a correct prediction or classification for the example observation. Similarly, the one or more negative task embeddings for each example observation can be generated by the text embedding neural network processing corresponding text prompts that are not associated with the example observation. As an example, each negative task embedding for an example observation can be generated by the text embedding neural network processing corresponding text prompts describing an incorrect prediction or classification for the example observation. As another example, when the system trains the observation processing system using batches of training examples, each negative task embedding for an example observation from a given batch of training examples can be generated by the text embedding neural network processing the text prompts describing correct predictions or classifications for the other example observations from the given batch of training examples.

The contrastive loss can reward similarity scores for positive task embeddings and can penalize similarity scores for negative task embeddings. For example, the contrastive loss for an observation embedding x can be determined following:

$$ℒ ( x ) = - log \frac{{e}^{s ( x , {z}^{+} )}}{{e}^{S ( x , {z}^{+} )} + {\sum }_{i} {e}^{S ( x , {z}_{i}^{-} )}}$$

Where S(x, z) denotes the similarity score for the observation embedding x and task embedding z, z⁺ is a positive task embedding for the observation embedding x, and each

$${z}_{i}^{-}$$

is a negative task embedding for the observation embedding x. Other examples of contrastive losses are described by Oord et al. in “Representation Learning with Contrastive Predictive Coding”, Radford et al. in “Learning Transferable Visual Models from Natural Language Supervision”, and Yu et al. in “CoCa: Contrastive Captioners are Image-Text Foundation Models”.

Each training example can include a task embedding associated with the observation for the training example (e.g., a task embedding for a target classification label for the observation) and a plurality of task embeddings that are not associated with the observation for the training example (e.g., task embeddings for classification labels different from the target classification label for the observation). By including a contrastive loss based on the similarity scores between the observations and the task embeddings, the objective function can encourage the observation processing system to generate embeddings for the observations that (i) are similar to the task embeddings that are associated with the observations and (ii) are dissimilar to the task embeddings that are not associated with the observations.

When the training data includes training data for a plurality of prediction tasks, the contrastive loss can encourage the observation processing system to generate observation embeddings that remain similar to associated task embeddings for prediction tasks that are not included within the training data for the observation processing system. The contrastive loss therefore can enable zero-shot learning (e.g., learning to generate predictions for previously unseen prediction tasks) and few-shot learning (e.g., learning to generate predictions for rarely seen prediction tasks) by the observation processing system.

In some implementations, before training using the process 400, the observation processing system can be pre-trained to optimize the contrastive loss between observation embeddings for example observations and text embeddings for text descriptions of the example observations. Pre-training to optimize the contrastive loss between observation embeddings for example observations and text embeddings for text descriptions of the example observations can enable the observation processing system to learn similarities between observations and general text descriptions of the observations, which can benefit zero-shot learning and few-shot learning by the observation processing system to generate predictions for the vehicle. When the embedding system of the observation processing system includes task-specific projection neural networks, embedding system can be pre-trained without using the task-specific projection neural networks to produce task independent observation embeddings.

The system can update the prediction system to optimize the objective function (step 408). The system can update the prediction system to optimize the objective function using any appropriate machine learning technique. For example, the system can determine gradients of the objective function and can update parameters of the prediction system using the determined gradients (e.g., following stochastic gradient descent, ADAM, etc.).

In some implementations, the system can update the embedding system of the observation processing system to optimize the objective function (step 410). In particular, the system can jointly train the embedding system of the observation processing system with the prediction system to optimize the objective function using the set of training data. For example, when the system updates the prediction system using gradients of the objective function, the system can update parameters of the embedding system by backpropagating the gradients of the objective function through prediction neural networks of the prediction system.

When the training examples include data specifying projection neural networks of the embedding system to be used to generate task-specific observation embeddings for the training examples, the system can update the projection neural networks of the embedding system to optimize the objective function.

When the observation processing system is pre-trained using the contrastive loss, the embedding system can be updated by only updating the projection neural networks of the embedding system, which can train the embedding system to generate task-specific observation embeddings while also retaining the ability to generate task independent observation embeddings. As an example, the observation encoding system can include task-specific projection neural networks trained to perform uncommon prediction tasks that can have limited available training data and can require specialized processing and training (e.g., long-tail prediction tasks, such as classifying obstructed objects and pedestrians, identifying rare pedestrian gestures, predicting a physical security of the vehicle, etc.). Updating the embedding system by only updating the projection neural networks of the embedding system can therefore benefit zero-shot learning and few-shot learning by the observation processing system to generate predictions for the vehicle.

In some implementations, the system can update the task embeddings for the training examples to optimize the objective function (step 412). In particular, when the task embeddings for the training example are generated by another sub-system of the vehicle, the system can jointly train the other sub-system of the vehicle with the prediction system to optimize the objective function (e.g., by backpropagating gradients of the objective function through prediction neural networks of the prediction system to update parameters of the other sub-system). For example, when the example task embeddings are machine-learned parameters (e.g., machine learned vectors) stored by the other sub-system of the vehicle, the system can directly update the example task embeddings to optimize the objective function. As another example, when the other sub-system of the vehicle generates the example task embeddings by processing corresponding text prompts using a text embedding neural network (e.g., using a language model), the system can jointly train the other sub-system to optimize the objective function by, e.g., updating parameters of the text embedding neural network to optimize the objective function, updating the text prompts used generate the example text embeddings to optimize the objective function (e.g., by selecting updated text prompts from a set of possible text prompts), and so on. When the other sub-system of the vehicle generates the task embeddings using a text embedding neural network, the other system can store (e.g., re-cache) the updated task embeddings.

The text embedding neural network can be an off-board text embedding neural network and the other sub-system of the vehicle can receive and store (e.g., cache) the updated text embeddings as generated by the off-board text embedding neural network. For example, the other sub-system of the vehicle can be configured to transmit (e.g., to an off-board training system, an external database, etc) queries requesting updated task embeddings and can receive and store updated text embeddings as generated by the off-board text embedding neural network.

FIG. 5A is a block diagram for an example observation processing system 120 configured to generate output predictions regarding specific spatial regions of a driving environment of a vehicle.

As described above the observation processing system 120 can process sensor data 114 characterizing an observation of the driving environment to generate output predictions 202 regarding the driving environment of the vehicle. In particular, the system 120 can receive (e.g., from another sub-system of the vehicle) one or more region proposals 502 that characterize respective spatial regions of the observation to generate output predictions 202 regarding the spatial regions specified by the region proposals 502.

The region proposals 502 can specify any of a variety of spatial regions of the observation and can be associated with any of a variety of, e.g., areas of the driving environment of the vehicle, objects in the driving environment of the vehicle, agents (e.g., vehicles, pedestrians, etc.) in the driving environment of the vehicle, and so on. For example, the region proposals 502 can include bounding boxes for objects (e.g., vehicles, pedestrians, obstacles, etc.) within the driving environment of the vehicle specify respective locations and spatial extents of the objects. As another example, the region proposals 502 can specify areas of the observation (e.g., including non-rectangular spatial regions of the observation, irregular spatial regions of the observation, etc.) associated with, e.g., roadways, lanes, intersections, entrances, exits, vehicles, objects, pedestrians, and so on within the driving environment of the vehicle.

The observation processing system 120 can receive the region proposals 502 from another subsystem of the vehicle (e.g., from a perception system of the vehicle, from a navigation system of the vehicle, etc.). The region proposals 502 can be generated by the other sub-system of the vehicle as part of the other sub-system of the vehicle performing any of a variety of processing tasks using the observation of the sensor data 114. For example, the region proposals 502 can include object detection data generated by the other sub-system (e.g., bounding boxes for objects detected the other sub-system of the vehicle performing object detection using the observation of the sensor data 114). As another example, region proposals 502 can include segmentation data generated by the other sub-system (e.g., segmentation data generated by the other sub-system of the vehicle performing segmentation of the observation of the sensor data 114).

As described above with reference to FIG. 2, the observation processing system 120 includes an embedding system 204. The embedding system 204 can process the sensor data 114 characterizing the observation and the region proposals 502 to generate region embeddings 504 for the spatial regions of the observation specified by the region proposals 502.

The embedding system 204 can include an observation embedding neural network 506 and a region embedding neural network 508, which are each described next.

The observation embedding neural network 506 can process the sensor data 114 for the observation to generate an observation embedding 510 characterizing the observation. The observation embedding 510 can include a plurality of observation features that represents the observation. Each of the observation features can be associated with a respective spatial location within the observation. Each observation feature can characterize a portion (e.g., a spatial region) of the observation containing the spatial location of the observation associated with the observation feature.

The observation embedding neural network 506 can include any of a variety of processing layers (e.g., convolutional layers, graph processing layers, recurrent layers, attention layers, and so on) for processing the sensor data 114 for the observation to generate the observation embedding 510. The observation embedding neural network 506 can be trained to generate the observation embedding 510 as part of training the embedding system 204 (e.g., as described in more detail above with reference to FIG. 4).

The region embedding neural network 508 can process the region proposals 502 and the observation embedding 510 to generate the region embeddings 504 characterizing the spatial regions of the observation specified by the region proposals 502. In particular, the region embedding neural network 508 can process the observation embedding 510 and the region proposals 502 to generate respective region embeddings 504 for each of the region proposals 502. For each of the region proposals 502, the region embedding for the region proposal can include region features that characterize the spatial region of the observation specified by the region proposal.

Each of the region proposals 502 can specify a spatial region of the observation that includes a portion (e.g., a proper subset) of the spatial locations within the observation associated with the observation features of the observation embedding 510. As described in more detail below with reference to FIG. 5B, the region embedding neural network 508 can, for each of the region proposals 502, determine region features for the region proposal (e.g., observation features of the observation embedding 510 that are associated with the spatial region specified by the region proposal) and process the identified region features for the region proposal to generate the region embedding for the region proposal.

The region embedding neural network 508 can include any of a variety of processing layers (e.g., convolutional layers, graph processing layers, recurrent layers, attention layers, and so on) for processing the region proposals 502 and the observation embedding 510 to generate the region embeddings 504. The region embedding neural network 508 can be trained to generate the region embeddings 504 as part of training the embedding system 204 (e.g., as described in more detail above with reference to FIG. 4).

In some implementations, as described in more detail above with reference to FIG. 2 and FIG. 3, the embedding system 204 can receive (e.g., from a sub-system of the vehicle, such as a planning system of the vehicle, a user interface system of the vehicle, and so on) task data 210 that characterizes a particular prediction task. The embedding system 204 can include one or more projection neural networks and can generate task-specific region embeddings 504 for the particular prediction task using a projection neural network specified by the task data 210.

As an example, the embedding system 204 can include one or more observation projection neural networks configured to process initial observation embeddings (e.g., as generated by the observation embedding neural network 506) to generate task-specific observation embeddings 510. When the embedding system 204 receives task data 210 specifying a particular prediction task, the system 204 can select an observation projection neural network (e.g., as specified by the task data 210) and can process an initial observation embedding generated by the observation embedding neural network 506 using the selected observation projection neural network to generate the task-specific observation embedding 510 for the particular prediction task.

As another example, the embedding system 204 can include one or more region projection neural networks configured to process initial region embeddings (e.g., as generated by the region embedding neural network 508) to generate task-specific region embeddings 504. When the embedding system 204 receives task data 210 specifying a particular prediction task, the system 204 can select a region projection neural network (e.g., as specified by the task data 210) and can process initial region embeddings generated by the region embedding neural network 508 using the selected region projection neural network to generate the task-specific region embeddings 510 for the particular prediction task.

As described in more detail above with reference to FIG. 2 and FIG. 3, the observation processing system 120 includes a prediction system 206 configured to process the region embeddings 504 to generate the output predictions 202 for the spatial regions of the observation specified by the region proposals 502. The prediction system 206 can receive the task data 210 that characterizes a particular prediction task. When the prediction system 206 receives task data 210 characterizing a particular prediction task, the prediction system 206 can process the region embeddings 504 and the task data 210 to generate the output prediction 202 for the particular task and for the spatial regions of the observation specified by the region proposals 502.

In particular, the task data 210 can characterize classification labels for the particular prediction task. For example, the task data 210 can characterize classification labels for a state of regions (e.g., regions specified by the region proposals 502) of the driving environment of the vehicle (e.g., classification of whether the regions are safe to enter, unsafe to enter, obstructed, flooded, etc.). As another example, the task data 210 can characterize classification labels for other agents (e.g., vehicles, pedestrians, pedestrian gestures, objects associated with spatial regions specified by the region proposals, etc.) in the driving environment of the vehicle (e.g., classifications of types of the agents, whether the agents are damaged, whether the agents are moving, whether the agents are merging, etc.).

An example process using the observation processing system 120 to generate output predictions 202 regarding specific spatial regions of the driving environment of the vehicle is described in more detail below with reference to FIG. 5C.

FIG. 5B illustrates generating a region embedding 504 that characterizes a specific spatial region 512 of an observation 514 of a driving environment.

As described above, the observation 514 can be obtained by sensors of a vehicle in a driving environment. The spatial region 512 of the observation 514 can be any of a variety of spatial regions of the observation and can be associated with any of a variety of, e.g., areas of the driving environment of the vehicle, objects in the driving environment of the vehicle, agents (e.g., vehicles, pedestrians, etc.) in a driving environment of a vehicle, and so on. For example, the spatial region 512 can be a bounding box for an object (e.g., vehicles, pedestrians, obstacles, etc.) within the driving environment of the vehicle. As another example, the spatial region 512 can be an area of the observation 514 (e.g., a non-rectangular spatial region of the observation 514, an irregular spatial region of the observation 514, etc.) associated with, e.g., a roadway, lane, intersection, entrance, exit, vehicle, object, pedestrian, and so on within the driving environment of the vehicle.

An observation processing system (e.g., the observation processing system 120 of FIG. 1A) can process the observation 514 to generate an observation embedding 510 that characterizes the observation 514. The observation embedding 510 includes a plurality of observation features that represents the observation 514. Each of the observation features can be associated with a respective spatial location within the observation 514. Each observation feature can characterize a portion (e.g., a spatial region) of the observation 514 containing the spatial location of the observation 514 associated with the observation feature.

For illustrative purposes, FIG. 5B depicts the observation embedding 510 as a 2-dimensional grid of 25 observation features (e.g., associated with a corresponding 2-dimensional grid of 25 spatial locations within the observation 514). However, the observation embedding 510 can generally include any number of observation features associated with any arrangement of spatial locations of the observation 514.

The observation processing system can identify features of the observation embedding 510 that are associated with the specific spatial region 512 of the observation 514. The observation processing system can use any appropriate criteria to identify which features of the observation embedding 510 are associated with the spatial region 512. For example, the observation processing system can identify features of the observation embedding 510 as being associated with the spatial region 512 when the spatial region 512 includes the spatial locations of the observation 514 associated with the features of the observation embedding 510. As another example, the observation processing system can identify features of the observation embedding 510 as being associated with the spatial region 512 when the spatial region 512 includes a pre-defined fraction of spatial regions of the observation 514 associated with the features of the observation embedding 510.

The observation processing system can process the identified features of the observation embedding 510 associated with the specific spatial region 512 to generate the region embedding 504 characterizing the specific spatial region 512. The region embedding 504 can include a plurality of region features that are each associated with a respective spatial location within the specific spatial region 512 (and by extension, a respective spatial location within the observation 514).

The observation processing system 120 can generate the region embedding 504 by combining the identified features of the observation embedding 510 associated with the specific spatial region 512. For example, the observation processing system can generate each of the region features by performing a pooling operation (e.g., a max-pooling operation, an average pooling operation, etc.) to combine one or more of the identified features of the observation embedding 510 for the region feature. As a further example, the region embedding 504 can include a single region feature that can be generated by performing a pooling operation that combines all of the identified features of the observation embedding 510 associated with the specific spatial region 512. As another example, the region embedding 504 can include multiple region features that are each associated with a respective portion of the spatial region 512, and the system 120 can generate the region features by performing a pooling operation that combines features of the observation embedding 510 that are associated with the portions of the spatial region 512 for the region features.

For illustrative purposes, FIG. 5B depicts the region embedding 504 as a 2-dimensional grid of 4 region features (e.g., associated with a corresponding 2-dimensional grid of 4 spatial locations for the region 512). However, observation embedding 510 can generally include any number of region features associated with any arrangement of spatial locations for the region 512.

In some implementations, the observation processing system can generate the region embedding 504 to include a fixed number of region features characterizing the spatial region 512. For example, when the observation processing system determines similarity scores between region embeddings and task embeddings, the observation processing system can generate the region embedding 504 to have a same shape and dimensionality as the task embeddings.

FIG. 5C is a flow diagram of an example process for generating a prediction for specific spatial regions of a driving environment of a vehicle by processing sensor data characterizing the driving environment. For convenience, the process 520 will be described as being performed by a system of one or more computers located in one or more locations. For example, an observation processing system, e.g., the observation processing system 120 of FIG. 1A, appropriately programmed in accordance with this specification, can perform the process 520.

The system can receive sensor data that characterizes an observation of the driving environment of the vehicle as obtained by sensors of the vehicle (step 522). For example, the sensor data can characterize an observation of, e.g., image data obtained by camera sensors of the vehicle, point-cloud data obtained by LIDAR sensors of the vehicle, RADAR data obtained by the RADAR sensors of the vehicle, and so on.

The system can receive the sensor data as generated by a perception system of the vehicle. The sensor data can include any of a variety of data resulting from the perception system of the vehicle processing the observations of the sensor data.

The system can process the received sensor data to generate an observation embedding for the observation (step 524). For example, the system can process the observation using an observation embedding neural network to generate the observation embedding.

The observation embedding can include a plurality of observation features that represent the observation. Each of the observation features can be associated with a respective spatial location within the observation. Each observation feature can characterize a portion (e.g., a spatial region) of the observation containing the spatial location of the observation associated with the observation feature.

In some implementations, the system can generate a task-specific observation embedding for the particular prediction task. For example, the system can include one or more observation projection neural networks configured to process initial observation embeddings (e.g., as generated by the observation embedding neural network) to generate task-specific observation embeddings. The system can select an observation projection neural network for the particular prediction task and can process an initial observation embedding generated by the observation embedding neural network using the selected observation projection neural network to generate the task-specific observation embedding for the particular prediction task.

The system can receive a region proposal that characterizes a spatial region of the observation (step 526). The region proposal can specify any of a variety of spatial regions of the observation and can be associated with any of a variety of, e.g., areas of the driving environment of the vehicle, objects in the driving environment of the vehicle, agents (e.g., vehicles, pedestrians, etc.) in the driving environment of the vehicle, and so on. For example, the region proposal can be a bounding box for an object (e.g., a vehicle, pedestrian, obstacle, etc.) within the driving environment of the vehicle that specifies a location and spatial extent of the object. As another example, the region proposals can specify an area of the observation (e.g., a non-rectangular spatial region of the observation, an irregular spatial region of the observation, etc.) associated with, e.g., a roadway, lane, intersection, entrance, exit, vehicle, object, pedestrian, and so on within the driving environment of the vehicle.

The region proposal can be generated by a perception system of the vehicle (e.g., generated as a result of the perception system processing the observation of the sensor data). For example, the region proposal can include object detection data generated by the perception system (e.g., bounding boxes for objects detected the perception system of the vehicle performing object detection using the observations of raw sensor data). As another example, region proposal can include segmentation data generated by the perception system (e.g., segmentation data generated by the perception system of the vehicle performing segmentation of the observations of raw sensor data).

The system can process the region proposal and the observation embedding to generate a region embedding for the spatial region specified by the received region proposal (step 528). The region embedding can include a plurality of region features that are each associated with a respective spatial location within spatial region of the observation specified by the received region proposal.

As described above with reference to FIG. 5B, the system can generate the region embedding by combining observation features of the observation embedding associated with spatial region specified by the region proposal. For example, the system can generate each of the region features by performing a pooling operation (e.g., a max-pooling operation, an average pooling operation, etc.) to combine one or more observation features for the region feature. As a further example, the region embedding can include a single region feature that can be generated by performing a pooling operation that combines all of the observation features associated with the spatial region specified by the region proposal. As another example, the region embedding can include multiple region features that are each associated with a respective portion of the spatial region specified by the region proposal, and the system can generate the region features by performing a pooling operation that combines observation features that are associated with the portions of the spatial region associated with the region features.

In some implementations, the system can generate the region embedding to include a fixed number of region features characterizing the spatial region.

In some implementations, the system can generate a task-specific region embedding for the particular prediction task. For example, the system can include one or more region projection neural networks configured to process initial region embeddings to generate task-specific region embeddings. The system can select a region projection neural network (e.g., as specified by the task data) and can process an initial region embedding generated as described above using the selected region projection neural network to generate the task-specific region embedding for the particular prediction task.

The system can process the received task data and the generated region embedding to generate a prediction output for the particular prediction task (step 532).

As an example, the system can process the task data and the generated region embedding using a language model (e.g., a vision language model) configured to process an input token sequence that includes the region embedding and embeddings of the task data to generate an output token sequence characterizing the output prediction.

As another example, system can process the task data and the generated region embedding using a prediction neural network configured to process a network input that includes (i) the region embedding and (ii) embeddings for classification labels for the particular prediction task (e.g., as included within the task data for the particular prediction task). For each embedding for a classification label, the prediction neural network can determine a similarity score that characterizes a likelihood that the region embedding is associated with the classification label. The prediction neural network can generate the prediction output to include, e.g., the determined similarity scores of the classification labels for the region embedding, the classification labels determined to have the highest similarity scores for the region embedding, and so on.

The system can provide the generated prediction output for processing by other sub-systems of the vehicle (step 534). The other sub-systems of the vehicle can process the output prediction to perform any of a variety of tasks for the vehicle. For example, the system can provide the generated output prediction to a planning system of the vehicle that can process the prediction to determine one or more planned control inputs for the vehicle. The planned control inputs can be used to control the vehicle (e.g., to perform a navigation task for the vehicle within the driving environment for the vehicle). As another example, the system can provide the output predictions to a user interface system of the vehicle that can, e.g., provide information to a user of the vehicle regarding the driving environment of the vehicle based on the output prediction, warn a user of the vehicle about unsafe driving conditions based on the output prediction, and so on.

FIG. 6A is a block diagram for an example observation processing system 120 configured to generate output predictions for sequences of observations of a driving environment using multiple specialized processing networks.

The observation processing system 120 is configured to process a sequence of observations 602 of the driving environment to generate output predictions 202 regarding the driving environment.

The sequence of observations 602 can include observations of the driving environment of the vehicle for any of a variety of sensors of the vehicle. For example, the sequence of observations 602 can include observations of, e.g., image data obtained by camera sensors of the vehicle, point-cloud data obtained by LIDAR sensors of the vehicle, RADAR data obtained by the RADAR sensors of the vehicle, and so on.

As described above with reference to FIG. 2, the observation processing system 120 includes an embedding system 204 and a prediction system 206. The embedding system 204 can process the sequence of observations 602 to generate observation embeddings 208 for each of the sequence of observations. The prediction system 206 can process the observation embeddings to generate the output predictions 202.

The prediction system 206 can receive task data 210 that characterizes particular prediction tasks. When the prediction system 206 receives task data 210, the prediction system 206 can process the observation embeddings and the task data 210 to generate the output predictions 202 to perform the particular prediction tasks for the sequence of observations 602.

In particular, the task data 210 can characterize classification labels for the particular prediction tasks. For example, the task data 210 can characterize classification labels for states of the driving environment of the vehicle (e.g., classifications of whether the driving environment is safe, unsafe, obstructed, flooded, etc.). As another example, the task data 210 can characterize classification labels for states of regions of the driving environment of the vehicle (e.g., classifications of whether the regions are safe to enter, unsafe to enter, obstructed, flooded, etc.). As another example, the task data 210 can characterize classification labels for states of the vehicle (e.g., classifications of whether the vehicle is operating safely, operating unsafely, damaged, operating unexpectedly, is experiencing a loss of control, is physically secure, etc.). As another example, the task data 210 can characterize classification labels for other agents (e.g., vehicles, pedestrians, pedestrian gestures, objects, etc.) in the driving environment of the vehicle (e.g., classifications of types of the agents, whether the agents are damaged, whether the agents are moving, whether the agents are merging, etc.).

The embedding system 204 and the prediction system 206 can each include multiple processing networks that can perform different specialized processing tasks as part of generating the output predictions 202 for the sequence of observations 602. For example, the embedding system 204 can include embedding networks 604-A and 604-B configured to process observations from the sequence of observations 602 to generate respective observation embeddings 208-A and 208-B. The prediction system 206 can include prediction networks 606-A and 606-B configured to process the observation embeddings 208-A and 208-B, respectively, to generate the respective output predictions 202-A and 202-B.

The embedding network 604-A and the prediction network 606-A can be specialized to perform short-term prediction tasks (e.g., generate output predictions 202-A for short term prediction tasks) with a lower latency (e.g., computational time), while the embedding network 604-B and the prediction network 606-B can be specialized to perform long-term prediction tasks (e.g., generate output predictions 202-B for long term tasks) that require more computational resources.

For example, the embedding networks 604-A and 606-B can be specialized to process respective observations from the sequence of observations. As a further example, the embedding network 604-A can be configured to process each observation of the sequence of observations 602 while the embedding network 604-B can be configured to process only some of the sequence of observations 602. As another example, when the sequence of observations 602 includes observations from a plurality of sensors of the vehicle, the embedding neural network 604-A can be configured to process observations that include sensor data obtained by a smaller subset of the sensors of the vehicle (e.g., front-facing sensors of the vehicle, cameras of the vehicle, etc.) while the embedding neural network 604-B can be configured to process observations that include sensor data obtained by a larger subset of the sensors of the vehicle (e.g., observations of combined sensor data for sensors around the vehicle, observations of combined sensor data for multiple sensor modalities, etc.).

As another example, the embedding networks 604-A and 606-B can include respective projection neural networks for particular prediction tasks and can be configured to generate task-specific observation embeddings 208-A and 208-B using projection neural networks specified by the task data 210. The embedding networks 604-A and 606-B can include different projection neural networks for generating task-specific observation embeddings for different sets of processing tasks. For example, the embedding network 604-A can include projection networks for short-term prediction tasks (e.g., prediction tasks relating to the immediate safety of the vehicle) while the embedding network 604-B can include projection neural networks for long-term prediction tasks (e.g., prediction tasks relating to long-term navigation planning for the vehicle).

As another example, the prediction networks 606-A and 606-B can be specialized to process task data 210 for respective processing tasks. For example, the prediction network 606-A can be configured to process task data 210 for short-term prediction tasks (e.g., prediction tasks relating to the immediate safety of the vehicle) while the prediction network 606-B can be configured to process task data 210 for long-term prediction tasks (e.g., prediction tasks relating to long-term navigation planning for the vehicle).

As another example, the embedding networks 604-A and 604-B and the prediction networks 606-A and 606-B can have respective specialized network architectures. For example, the embedding network 604-A can have a simpler network architecture with fewer network weights compared to the embedding network 604-B. In particular, the embedding network 604-A can be a distillation of the embedding network 604-B (e.g., trained to reproduce network outputs generated by the embedding network 604-B). Similarly, the prediction network 606-A can have a simpler network architecture with fewer network weights compared to the prediction network 606-B (e.g., prediction network 606-A can be a distillation of the prediction network 606-B).

In some implementations, the prediction network 606-A can be configured to process observation embeddings 208-B generated by the embedding network 204-B as part of generating the output predictions 202-A. For example, the prediction network 606-A can process network input that includes the observation embeddings 208-A and 208-B, receive the observation embeddings 206-B as conditioning data for processing the observation embeddings 208-A, and so on. In particular, when the prediction network 606-A processes observation embeddings 208-A for an observation of the observation sequence 602, the prediction network 606-A can process observation embeddings 208-B for a preceding observation of the sequence 602 as an additional input for generating the output prediction 204-A. When the embedding network 204-A has a simpler network architecture compared to the embedding network 204-B (e.g., when the embedding network 204-A is a distillation of the embedding network 206-B), processing previously generated observation embeddings 208-B can enable the prediction neural network 206-A to generate short-term, low-latency output predictions 202-A based on both (i) the lower quality but more recent observation embeddings 208-A and (ii) the higher quality but time delayed observation embeddings 208-B.

An example process for generating the output predictions 202-A and 202-B for the sequences observations 602 using the multiple specialized processing networks of the embedding system 204 and the prediction system 206 is described in more detail below with reference to FIG. 6B.

FIG. 6B is a flow diagram of an example process for generating predictions for sequences of observations of a driving environment using multiple specialized processing networks. For convenience, the process 630 will be described as being performed by a system of one or more computers located in one or more locations. For example, an observation processing system, e.g., the observation processing system 120 of FIG. 1A, appropriately programmed in accordance with this specification, can perform the process 630.

The system can receive sensor data for a sequence of observations (step 632). The sequence of observations can include observations of the driving environment of the vehicle for any of a variety of sensors of the vehicle. For example, the sequence of observations can include observations of, e.g., image data obtained by camera sensors of the vehicle, point-cloud data obtained by LIDAR sensors of the vehicle, RADAR data obtained by the RADAR sensors of the vehicle, and so on.

In some implementations, the system can receive task data characterizing prediction tasks for the sequence of observations (step 634). For example, the task data can characterize classification labels for states of the driving environment of the vehicle (e.g., classifications of whether the driving environment is safe, unsafe, obstructed, flooded, etc.), classification labels for states of regions of the driving environment of the vehicle (e.g., classifications of whether the regions are safe to enter, unsafe to enter, obstructed, flooded, etc.), classification labels for states of the vehicle (e.g., classifications of whether the vehicle is operating safely, operating unsafely, damaged, operating unexpectedly, is experiencing a loss of control, is physically secure, etc.), classification labels for other agents (e.g., vehicles, pedestrians, pedestrian gestures, objects, etc.) in the driving environment of the vehicle (e.g., classifications of types of the agents, whether the agents are damaged, whether the agents are moving, whether the agents are merging, etc.), and so on.

The system can process each observation of the sequence of observations using one or more embedding networks for the observation to generate one or more corresponding observation embeddings for the observation (step 636). In particular, the system can process the sequence of observations using multiple specialized embedding networks to generate the observation embeddings. Each of the embedding networks can, e.g., have a respective specialized network architecture, be configured to process a respective subset of the sequence of observations, include one or more projection neural networks for prediction tasks for which the embedding network is specialized to perform, and so on.

For example, the system can process each observation of the sequence of observations using a first embedding network (e.g., following step 306 of the process 300 described above with reference to FIG. 3) to generate a first observation embedding for each observation. The system can process one or more observations of the sequence of observations using a second embedding network (e.g., following step 306 of the process 300 described above with reference to FIG. 3) to generate second observation embeddings for the one or more observations.

In some implementations, the first embedding network can have a simpler network architecture with fewer network weights than the second embedding network. For example, the first embedding network can be a distillation of the second embedding network. The first embedding network can be trained to be a distillation of the second embedding network by training the first embedding network to optimize an objective function that measures a similarity between network outputs produced by the first embedding network and the second embedding network when processing the same network inputs. For example, the first embedding network can be trained to be a distillation of the second embedding network by training the first embedding network to optimize the Kullback-Liebler divergence:

$${D}_{K L} ( p ( {f}_{θ} ( x ) ) \vert \vert p ( {g}_{ϕ} ( x ) ) )$$

Where p(ƒ_{θ}(x)) is a distribution of observation embeddings defined by the likelihoods of the observation embeddings determined by processing the observation x using the second embedding network and p(g_{φ}(x)) is a distribution of observation embeddings defined by the likelihoods of the observation embeddings determined by processing the observation x using the first embedding network.

When the first embedding network has a simpler network architecture than the second embedding network, the first embedding network can generate observation embeddings more quickly (e.g., with less latency) than the second embedding network. Within a given length of time, the first embedding network can therefore generate more observation embeddings than the second embedding network. For example, the reduced processing latency of the first embedding network can enable the first embedding network to generate K observation embeddings (where K is an integer greater than one) in the same time required by the second embedding neural network to generate one observation embedding. Therefore, in some implementations, the system can process each of the sequence of observations using the first embedding network while only processing some of the sequence of observations using the second embedding network. For example, when the first embedding network can generate K observation embeddings (where K is an integer greater than one) in the same time required by the second embedding neural network to generate one observation embedding, the system can process each of the sequence of observations using the first embedding network while only processing every K-th observation of the sequence of observations using the second embedding network.

The system can process the observation embeddings generated for each of the sequence of observations using one or more prediction networks for the observation to generate one or more prediction outputs for the observation (step 638). In particular, the system can process the observation embeddings using multiple specialized prediction networks to generate the output predictions. Each of the prediction networks can, e.g., have a respective specialized network architecture, be configured to process a respective subset of the observation embeddings, be configured to process a respective subset of the received task data, and so on.

For example, when the system generates the observation embeddings using a first embedding network and a second embedding network, the system can process the observation embeddings generated by the first embedding network and received task data for a first prediction task using a first prediction network (e.g., following step 308 of the process 300 described above with reference to FIG. 3) to generate corresponding output predictions for the first prediction task. The system can process the observation embeddings generated by the second embedding network and received task data for a second prediction task using a second prediction network (e.g., following step 308 of the process 300 described above with reference to FIG. 3) to generate corresponding output predictions for the second prediction task.

In some implementations, the first prediction network can be configured to receive and process observation embeddings generated by the second embedding network (e.g., the most recently generated observation embeddings generated by the second embedding network) as part of generating predictions for the first prediction task. When the first embedding network generates observation embeddings more quickly than the second embedding network (e.g., when the first embedding network has a simpler network architecture than the second embedding network), the first prediction network can process observation embeddings generated by the first embedding network for current observations alongside observation embeddings for previous observations generated by the second embedding network to generate the predictions for the first prediction task. Although time-delayed compared to the observation embeddings generated by the first embedding network, the observation embeddings generated by the second embedding network for the previous observations can provide additional context regarding the driving environment of the vehicle that the first prediction network can use as part of generating predictions for the first prediction task. In particular, the observation embeddings generated by the second embedding network can provide additional information to the first prediction network for performing the first prediction task, e.g., by being higher-quality embeddings generated by a more complex embedding network, by being embeddings of observations of a different data modality, by being embeddings of different observations, and so on.

In some implementations, the first prediction network can have a simpler network architecture with fewer network weights than the second prediction network. For example, the first prediction network can be a distillation of the second prediction network. The first prediction network can be trained to be a distillation of the second prediction network by training the first prediction network to optimize an objective function that measures a similarity between network outputs produced by the first prediction network and the second prediction network when processing the same network inputs. For example, the first prediction network can be trained to be a distillation of the prediction embedding network by training the first prediction network to optimize a Kullback-Liebler divergence between outputs generated by the first prediction network and outputs generated by the second prediction network.

When the first prediction network has a simpler network architecture than the second prediction network, the first prediction network can generate predictions more quickly than the second embedding network. Within a given length of time, the first prediction network can therefore generate more predictions than the second prediction network. The first prediction network can therefore be specialized to generate predictions for short-term prediction tasks (e.g., prediction tasks relating to an immediate safety of the vehicle) more quickly (e.g., with a lower latency) compared to the second prediction network while the second prediction network can be specialized to generate higher-quality predictions for more complex long-term prediction tasks (e.g., prediction tasks relating to longer-term planning for the vehicle).

The system can provide the generated output predictions for processing by other sub-systems of the vehicle (step 640). The other sub-systems of the vehicle can process the output predictions to perform any of a variety of tasks for the vehicle. For example, the system can provide the generated output predictions to a planning system of the vehicle that can process the predictions to determine one or more planned control inputs for the vehicle. The planned control inputs can be used to control the vehicle (e.g., to perform a navigation task for the vehicle within the driving environment for the vehicle). As another example, the system can provide the output predictions to a user interface system of the vehicle that can, e.g., provide information to a user of the vehicle regarding the driving environment of the vehicle based on the output prediction, warn a user of the vehicle about unsafe driving conditions based on the output prediction, and so on.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In addition to the embodiments described above, the following embodiments are also innovative:

Embodiment 1 is a method, performed by one or more computers, comprising: receiving sensor data comprising an observation of a driving environment obtained by a sensor of a vehicle in the driving environment; processing the observation of the driving environment using an observation embedding neural network to generate an observation embedding, wherein the observation embedding comprises respective observation features associated with each of a plurality of spatial locations within the observation of the driving environment; receiving data characterizing a prediction task from a first subsystem of the vehicle; receiving a region proposal from the first sub-system of the vehicle, wherein the region proposal specifies a spatial region of the observation of the driving environment; and generating output prediction data characterizing an output prediction for the prediction task and for the region proposal, comprising: processing the observation and the region proposal to generate region features characterizing the spatial region of the observation of the driving environment; and processing the region features and the data characterizing the prediction task to generate the output prediction data.

Embodiment 2 is the method of embodiment 1, wherein the data characterizing the prediction task comprises one or more task embeddings for the prediction task, wherein each task embedding for the prediction task represents a corresponding prediction for the prediction task.

Embodiment 3 is the method of embodiment 2, wherein: the prediction task is a classification task; and each task embedding for the prediction task represents a corresponding classification label for the prediction task.

Embodiment 4 is the method of embodiment 2 or embodiment 3, wherein processing the region features and the data characterizing the prediction task to generate the output prediction data comprises: processing the region features using a region embedding neural network to generate a region embedding; determining a respective measure of similarity between the region embedding and each of the one of more task embeddings for the prediction task; and generating the output prediction data based on the measures of similarity between the region embedding and each of the one or more task embeddings for the prediction task.

Embodiment 5 is the method of embodiment 4, wherein the region embedding neural network has been trained to optimize an objective function using a set of training data, wherein: the set of training data comprises a plurality of training examples, wherein each training example comprises (i) an example observation for the training example, (ii) an example region proposal for the training example, (iii) example task embeddings for the training example, and (iv) target prediction data for the training example; and the objective function measures an agreement between output prediction data generated using the region embedding neural network and corresponding target prediction data.

Embodiment 6 is the method of embodiment 5, wherein the region embedding neural network has been jointly trained with the observation embedding neural network to optimize the objective function using the set of training data.

Embodiment 7 is the method of any one of embodiments 1-6, wherein the spatial region of the observation specified by the region proposal includes a proper subset of the plurality of spatial locations within the observation of the driving environment.

Embodiment 8 is the method of any one of embodiments 1-7, wherein the spatial region of the observation specified by the region proposal is a bounding box within the observation of the driving environment.

Embodiment 9 is the method of any one of embodiments 1-8, wherein the spatial region of the observation specified by the region proposal is a non-rectangular spatial region of the observation of the driving environment.

Embodiment 10 is the method of embodiment 9, wherein the spatial region of the observation specified by the region proposal is an irregular spatial region of the observation of the driving environment.

Embodiment 11 is the method of any one of embodiments 1-10, wherein the region proposal is generated as a result of processing the observation of the driving environment by a perception system of the vehicle.

Embodiment 12 is the method of embodiment 11, wherein processing the observation of the driving environment by the perception system of the vehicle comprises: performing object detection using the observation of the driving environment.

Embodiment 13 is the method of embodiment 11, wherein processing the observation of the driving environment by the perception system of the vehicle comprises: performing segmentation of the observation of the driving environment.

Embodiment 14 is the method of any one of embodiments 1-13, wherein the region proposal characterizes an object within the driving environment.

Embodiment 15 is the method of embodiment 14, wherein the prediction task comprises predicting a state of the object characterized by the region proposal.

Embodiment 16 is the method of any one of embodiments 1-13, wherein the region proposal characterizes an area of the driving environment.

Embodiment 17 is the method of embodiment 16, wherein the prediction task comprises predicting a state of the area characterized by the region proposal.

Embodiment 18 is the method of any one of embodiments 1-17, wherein processing the observation and the region proposal to generate the region features characterizing the spatial region of the observation of the driving environment comprises processing the observation and the region proposal to generate a fixed number of region features characterizing the spatial region of the observation of the driving environment.

Embodiment 19 is the method of any one of embodiments 1-18, wherein: each region feature is associated with a respective portion of the spatial region specified by the region proposal; and processing the observation and the region proposal to generate region features characterizing the spatial region of the observation of the driving environment comprises generating each region feature by processing one or more observation features for the region feature, wherein the respective portion of the spatial region for the region feature includes the spatial locations associated with the one or more observation features for the region feature.

Embodiment 20 is the method of embodiment 19, wherein generating each region feature by processing the one or more observation features for the region feature comprises performing a pooling operation over the one or more observation features for the region feature.

Embodiment 21 is the method of embodiment 20, wherein the pooling operation comprises a max-pooling operation.

Embodiment 22 is the method of any one of embodiments 1-21, further comprising: providing the output prediction data to a second subsystem of the vehicle.

Embodiment 23 is the method of embodiment 22, wherein the second subsystem of the vehicle is a planning subsystem of the vehicle.

Embodiment 24 is the method of embodiment 23, further comprising: processing the output prediction data using the planning subsystem of the vehicle to determine one or more planned control inputs for the vehicle.

Embodiment 25 is the method of embodiment 24, further comprising: controlling the vehicle using the one or more planned control inputs for the vehicle.

Embodiment 26 is a method performed by one or more computers, comprising: receiving sensor data comprising a sequence of observations of a driving environment of a vehicle obtained by a sensor of the vehicle; processing the sensor data to generate, for each of the sequence of observations, a respective prediction output for the observation, comprising, for each of the sequence of observations, processing the observation using a first observation embedding neural network to generate a first embedding representing the observation and generating the prediction output for the observation based at least in part on the first embedding representing the observation, and, for one or more of the sequence of observations, processing the observation using a second observation embedding neural network to generate a second embedding representing the observation and generating the prediction output for the observation based at least in part on the second embedding representing the observation; and providing, to a subsystem of the vehicle, the generated prediction outputs for each of the sequence of observations.

Embodiment 27 is the method of embodiment 26, wherein processing the observation using the first observation embedding neural network to generate the first embedding representing the observation comprises: processing the observation and an observation embedding generated by the second neural network for a previous observation to generate the first embedding representing the observation as conditioned on the observation embedding generated by the second neural network for the previous observation.

Embodiment 28 is the method of embodiment 26 or embodiment 27, wherein generating the prediction output for the observation based at least in part on the first embedding representing the observation comprises generating output prediction data for a first prediction task following the method of any one of embodiments 1-21.

Embodiment 29 is the method of any one of embodiments 26-28, wherein generating the prediction output for the observation based at least in part on the second embedding representing the observation comprises generating output prediction data for a second prediction task following the method of any one of embodiments 1-21.

Embodiment 30 is the method of any one of embodiments 26-29, wherein the first observation embedding neural network comprise fewer network weights than the second observation embedding neural network.

Embodiment 31 is the method of embodiment 30, wherein the first observation embedding neural network has been trained by distillation of the second observation embedding neural network.

Embodiment 32 is the method of any one of embodiments 26-31, wherein, for each of the sequence of observations: the observation comprises observation data from a plurality of sensors; and processing the observation using the first observation embedding neural network to generate the first embedding representing the observation comprises processing the observation data from a proper subset of the plurality of sensors using the first observation neural network to generate the first embedding representing the observation.

Embodiment 33 is the method of any one of embodiments 26-32, wherein providing, to the subsystem of the vehicle, the generated prediction outputs for each of the sequence of observations comprises: providing, to a planning subsystem of the vehicle, the generated prediction outputs for each of the sequence of observations.

Embodiment 34 is the method of embodiment 33, further comprising: processing the prediction outputs using the planning subsystem of the vehicle to determine one or more planned control inputs for the vehicle.

Embodiment 35 is the method of embodiment 34, further comprising: controlling the vehicle using the one or more planned control inputs for the vehicle.

Embodiment 36 is one or more non-transitory computer storage media storing instructions that when executed by one or more computers cause the one or more computers to perform operations of the respective method of any one of embodiments 1-35.

Embodiment 37 is a system comprising: one or more computers; and one or more storage devices communicatively coupled to the one or more computers, wherein the one or more storage devices store instructions that, when executed by the one or more computers, cause the one or more computers to perform operations of the respective method of any one of embodiments 1-35.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method, performed by one or more computers, comprising:
receiving sensor data comprising an observation of a driving environment obtained by a sensor of a vehicle in the driving environment;
processing the observation of the driving environment using an observation embedding neural network to generate an observation embedding, wherein:
the observation embedding comprises respective observation features associated with each of a plurality of spatial locations within the observation of the driving environment;
receiving data characterizing a prediction task from a first subsystem of the vehicle;
receiving a region proposal from the first sub-system of the vehicle, wherein the region proposal specifies a spatial region of the observation of the driving environment; and
generating output prediction data characterizing an output prediction for the prediction task and for the region proposal, comprising:
processing the observation and the region proposal to generate region features characterizing the spatial region of the observation of the driving environment; and
processing the region features and the data characterizing the prediction task to generate the output prediction data.

2. The method of claim 1, wherein the data characterizing the prediction task comprises one or more task embeddings for the prediction task, wherein each task embedding for the prediction task represents a corresponding prediction for the prediction task.

3. The method of claim 2, wherein:
the prediction task is a classification task; and
each task embedding for the prediction task represents a corresponding classification label for the prediction task.

4. The method of claim 2, wherein processing the region features and the data characterizing the prediction task to generate the output prediction data comprises:
processing the region features using a region embedding neural network to generate a region embedding;
determining a respective measure of similarity between the region embedding and each of the one of more task embeddings for the prediction task; and
generating the output prediction data based on the measures of similarity between the region embedding and each of the one or more task embeddings for the prediction task.

5. The method of claim 4, wherein the region embedding neural network has been trained to optimize an objective function using a set of training data, wherein:
the set of training data comprises a plurality of training examples, wherein each training example comprises (i) an example observation for the training example, (ii) an example region proposal for the training example, (iii) example task embeddings for the training example, and (iv) target prediction data for the training example; and
the objective function measures an agreement between output prediction data generated using the region embedding neural network and corresponding target prediction data.

6. The method of claim 5, wherein the region embedding neural network has been jointly trained with the observation embedding neural network to optimize the objective function using the set of training data.

7. The method of claim 1, wherein the spatial region of the observation specified by the region proposal includes a proper subset of the plurality of spatial locations within the observation of the driving environment.

8. The method of claim 1, wherein the spatial region of the observation specified by the region proposal is a bounding box within the observation of the driving environment.

9. The method of claim 1, wherein the spatial region of the observation specified by the region proposal is a non-rectangular spatial region of the observation of the driving environment.

10. The method of claim 9, wherein the spatial region of the observation specified by the region proposal is an irregular spatial region of the observation of the driving environment.

11. The method of claim 1, wherein the region proposal is generated as a result of processing the observation of the driving environment by a perception system of the vehicle.

12. The method of claim 11, wherein processing the observation of the driving environment by the perception system of the vehicle comprises:
performing object detection using the observation of the driving environment.

13. The method of claim 11, wherein processing the observation of the driving environment by the perception system of the vehicle comprises:
performing segmentation of the observation of the driving environment.

14. The method of claim 1, wherein the region proposal characterizes an object within the driving environment.

15. The method of claim 14, wherein the prediction task comprises predicting a state of the object characterized by the region proposal.

16. The method of claim 1, wherein the region proposal characterizes an area of the driving environment.

17. The method of claim 16, wherein the prediction task comprises predicting a state of the area characterized by the region proposal.

18. The method of claim 1, wherein processing the observation and the region proposal to generate the region features characterizing the spatial region of the observation of the driving environment comprises processing the observation and the region proposal to generate a fixed number of region features characterizing the spatial region of the observation of the driving environment.

19. The method of claim 1, wherein:
each region feature is associated with a respective portion of the spatial region specified by the region proposal; and
processing the observation and the region proposal to generate region features characterizing the spatial region of the observation of the driving environment comprises:
generating each region feature by processing one or more observation features for the region feature, wherein the respective portion of the spatial region for the region feature includes the spatial locations associated with the one or more observation features for the region feature.

20. The method of claim 19, wherein generating each region feature by processing the one or more observation features for the region feature comprises performing a pooling operation over the one or more observation features for the region feature.

21. The method of claim 20, wherein the pooling operation comprises a max-pooling operation.

22. The method of claim 1, further comprising:
providing the output prediction data to a second subsystem of the vehicle.

23. The method of claim 22, wherein:
the second subsystem of the vehicle is a planning subsystem of the vehicle; and
the method further comprises:
processing the output prediction data using the planning subsystem of the vehicle to determine one or more planned control inputs for the vehicle.

24. The method of claim 23, further comprising:
controlling the vehicle using the one or more planned control inputs for the vehicle.

25. A method performed by one or more computers, comprising:
receiving sensor data comprising a sequence of observations of a driving environment of a vehicle obtained by a sensor of the vehicle;
processing the sensor data to generate, for each of the sequence of observations, a respective prediction output for the observation, comprising:
for each of the sequence of observations:
processing the observation using a first observation embedding neural network to generate a first embedding representing the observation; and
generating the prediction output for the observation based at least in part on the first embedding representing the observation; and
for one or more of the sequence of observations:
processing the observation using a second observation embedding neural network to generate a second embedding representing the observation; and
generating the prediction output for the observation based at least in part on the second embedding representing the observation; and
providing, to a subsystem of the vehicle, the generated prediction outputs for each of the sequence of observations.

26. The method of claim 25, wherein processing the observation using the first observation embedding neural network to generate the first embedding representing the observation comprises:
processing the observation and an observation embedding generated by the second neural network for a previous observation to generate the first embedding representing the observation as conditioned on the observation embedding generated by the second neural network for the previous observation.

27. The method of any one of claim 25, wherein:
the first observation embedding neural network comprises fewer network weights than the second observation embedding neural network.

28. The method of claim 27, wherein the first observation embedding neural network has been trained by distillation of the second observation embedding neural network.

29. The method of claim 25, wherein, for each of the sequence of observations:
the observation comprises observation data from a plurality of sensors; and
processing the observation using the first observation embedding neural network to generate the first embedding representing the observation comprises processing the observation data from a proper subset of the plurality of sensors using the first observation neural network to generate the first embedding representing the observation.

30. A system comprising:
one or more computers; and
one or more storage devices communicatively coupled to the one or more computers, wherein the one or more storage devices store instructions that, when executed by the one or more computers, cause the one or more computers to perform operations comprising:
receiving sensor data comprising an observation of a driving environment obtained by a sensor of a vehicle in the driving environment;
processing the observation of the driving environment using an observation embedding neural network to generate an observation embedding, wherein:
the observation embedding comprises respective observation features associated with each of a plurality of spatial locations within the observation of the driving environment;
receiving data characterizing a prediction task from a first subsystem of the vehicle;
receiving a region proposal from the first sub-system of the vehicle, wherein the region proposal specifies a spatial region of the observation of the driving environment; and
generating output prediction data characterizing an output prediction for the prediction task and for the region proposal, comprising:
processing the observation and the region proposal to generate region features characterizing the spatial region of the observation of the driving environment; and
processing the region features and the data characterizing the prediction task to generate the output prediction data.
